(19) United States
(12) Patent Application Publication
(10) Pub. No.: US 2026/0356259 A1
(43) Pub. Date: Nov. 12, 2026

(54) BACKREST REINFORCING MECHANISM

(71) Applicant: WONDERLAND SWITZERLAND AG, Steinhausen (CH)

(72) Inventors: Xiaolong MO, Dongguan, Guangdong (CN); Kun ZHANG, Dongguan, Guangdong (CN)

(73) Assignee: WONDERLAND SWITZERLAND AG, Steinhausen (CH)

(21) Appl. No.: 19/121,682

(22) PCT Filed: Oct. 17, 2023
(86) PCT No.: PCT/EP2023/078776

§ 371 Date: Apr. 16, 2025

(30) Foreign Application Priority Data
Oct. 17, 2022 (CN) 202211284745.6
Oct. 28, 2022 (CN) 202211339016.6
May 6, 2023 (CN) 202310507643.4

(51) Int. Cl. B60N 2/28

(52) U.S. Cl. CPC B60N 2/2884; B60N 2/2851; B60N 2/2872

(57) ABSTRACT

The disclosure relates to a backrest reinforcing mechanism, which is fixedly arranged on a front side and/or a rear side of a backrest portion of the child safety seat, so as to reinforce the backrest portion against deformation.

### CROSS-REFERENCE TO RELATED APPLICATION

The present application claims a priority benefit to CN. Application No. 2022112847456 filed on Oct. 17, 2022, titled “Side-impact protection mechanism and Child safety seat” and to CN. Application No. 2022113390166 filed on Oct. 28, 2022, titled “Backrest reinforcing mechanism and Child safety seat” and to CN. Application No. 2023105076434 filed on May 6, 2023, titled “A connecting assembly for a child safety seat and Child safety seat”, which applications are each incorporated herein by reference in their entirety.

### TECHNICAL FIELD

The present disclosure relates to a side-impact protection mechanism, a backrest reinforcing mechanism, a connecting assembly and a child safety seat.

### BACKGROUND

In order to improve the effect of side-impact protection, some existing child safety seats are generally provided with a side-impact protection block on side of the seat body. Some existing side-impact protection blocks need to be opened manually by users, but users often forget to open them, thus losing the role of side-impact protection.

### SUMMARY

A side-impact protection mechanism is provided according to the disclosure, the side-impact protection mechanism is arranged on a side of a backrest of a child safety seat and positioned at an opening on the child safety seat for a car-mounted safety belt to pass through, the side-impact protection mechanism includes: a side-impact protection block, pivotably arranged on the side of the backrest and has a spreaded state and a closed state, in the closed state, the side-impact protection block obstructs the opening, so as to prevent the car-mounted safety belt from passing therethrough, and in the spreaded state, the side-impact protection block protrudes laterally from the side of the backrest without obstructing the opening, such that the car-mounted safety belt is able to pass through the opening.

In an embodiment, two sides of the backrest are each provided with a side wing protruding forward, and the opening is defined by the side wing or jointly defined by the side wing and the backrest.

In an embodiment, in the closed state, the side-impact protection block is located in a middle of the opening and divides the opening into upper portion and lower portion which are not communicated to each other.

In an embodiment, the side-impact protection mechanism has a fixed base pivotably connected to the side-impact protection block, the fixed base is fixedly installed on a backrest side of the opening and has a pivoting portion, and the side-impact protection block is pivotably arranged on the pivoting portion.

In an embodiment, the side-impact protection block includes: a housing, pivotably arranged on the pivoting portion; a knob, slidably installed inside the housing, and exposed outside the housing for operation; a clamping block, slidably installed inside the housing and fixedly connected to the knob, the clamping block has a mounting end and a clamping end; and a spring, arranged between an inner wall of the housing and a mounting end of the clamping block and adapted to exert a force to push the clamping end of the clamping block out of the housing.

In an embodiment, the pivoting portion of the fixed base is provided with a clamping hole that is open outwardly, in the closed state, the clamping end of the clamping block abuts against an outer circumference of the pivoting portion, and retracts into the housing; in the spreaded state, the clamping end of the clamping block protrudes from the housing and is clamped into the clamping hole of the fixed base, and pushing the knob by overcoming the force of the spring cause the clamping block to retract into the housing, so as be released from clamping with the clamping hole.

In an embodiment, a torsion spring is arranged between the housing and the pivoting portion, and the torsion spring is adapted to exert a force to pivot the side-impact protection block to the closed state.

A child safety seat is provided according to the disclosure, and the child safety seat includes: a seat; a backrest, disposed above the seat; two side wings, respectively arranged on two sides of the backrest and above seat armrests of the seat; and the side-impact protection mechanism according to the disclosure, arranged on a side of the backrest.

In an embodiment, both sides of the backrest are each provided with one side-impact protection mechanism.

In an embodiment, the child safety seat has a Harness mode and a Booster mode, in the Harness mode, when the side-impact protection block is in the spreaded state, a shoulder harness of the car-mounted safety belt is able to sequentially pass through a gripper arranged at a connection of the backrest and the side wing and an upper portion of the opening, and a waistbelt of the car-mounted safety belt passes through the lower portion of the opening and then passes through a lower portion of an opening on the other side of the backrest together with the shoulder harness, so as to be inserted into and fixed with a safety belt buckle on a car seat; in the Booster mode, the shoulder harness of the car-mounted safety belt sequentially passes through a guide arranged between the backrest and a pillow, and passes under the armrest on one side, while the waistbelt of the car-mounted safety belt passes under the armrest on the other side, and then passes under the armrest on the one side together with the shoulder harness, so as to be inserted into and fixed with the safety belt buckle on the car seat.

A backrest reinforcing mechanism is provided according to the disclosure. The backrest reinforcing mechanism is fixedly arranged on a front side and/or a rear side of a backrest portion of the child safety seat, so as to reinforce the backrest portion against deformation.

In an embodiment, the backrest reinforcing mechanism is a rear backrest reinforcing mechanism installed on the rear side of the backrest portion in a form of a detachable reinforcing bracket.

In an embodiment, the reinforcing bracket is fixed to the rear side of the backrest portion by fastener, and a lower end of the reinforcing bracket is installed at a connection of the backrest portion and a seat portion of the child safety seat, wherein the lower end of the reinforcing bracket is retractable with respect to an upper end thereof.

In an embodiment, the reinforcing bracket includes an operating assembly to operate the lower end of the reinforcing bracket to expand and retract with respect to the upper end thereof.

In an embodiment, the backrest reinforcing mechanism is a rear backrest reinforcing mechanism and includes at least one first rod and at least one second rod fixedly connected to the first rod, the first rod and/or the second rod is fixed to the rear side of the backrest portion by a fastener and has respectively different extension directions; wherein the backrest reinforcing mechanism further includes at least one locking rod slidably sleeved with the at least one second rod, and one end of the at least one locking rod extends and protrudes from the sleeved at least one second rod, so as to be detachably installed at a corresponding position on the backrest portion.

In an embodiment, the backrest reinforcing mechanism is a rear backrest reinforcing mechanism and includes an upper first rod and a lower first rod arranged apart from each other, and a left second rod and a right second rod arranged apart from each other, and the left second rod and the right second rod are respectively fixed to the upper first rod and the lower first rod, thus forming a frame; the backrest reinforcing mechanism further includes two locking rods corresponding to the left second rod and the right second rod, and the two locking rods are respectively sleeved on and extend out of the left second rod and the right second rod, so as to be detachably installed to the backrest portion.

In an embodiment, a lower side of the backrest portion is correspondingly provided with a connecting hook having a locking hole, the locking rod is inserted into the corresponding locking hole.

In an embodiment, a resetting spring is arranged between the locking rod and the sleeved second rod, and the resetting spring is used for exerting a force on the locking rod to urge the locking rod to extend outwards and insert into the corresponding locking hole.

In an embodiment, the locking rod is sleeved inside the second rod; the second rod is provided with a chute and a limit hole below the chute, and a pin is inserted into the limit hole to position an upper end of the resetting spring; the locking rod is provided with a spring receiving portion and a connection hole above the spring receiving portion, and a lower end of the resetting spring is fixed on the spring receiving portion; and an operating assembly is inserted into the chute and the connection hole to guide the locking rod to slide upwardly and downwardly along the chute.

In an embodiment, a lower end of the spring receiving portion is provided with a limit post, the resetting spring is sleeved on the limit post, and an upper end of the spring receiving portion is provided with an avoidance notch for avoiding the pin.

In an embodiment, the backrest reinforcing mechanism is a front backrest reinforcing mechanism and is detachably installed on the front side of the backrest portion.

In an embodiment, the backrest reinforcing mechanism is a reinforcing sheet, a shape of the reinforcing sheet is matched with that of the backrest portion, the reinforcing sheet is provided with a perforation for a fastener to pass through and be fixed to a fixing hole on the backrest portion, and the perforation is arranged in an edge portion of the reinforcing sheet.

In an embodiment, the backrest reinforcing mechanism is a reinforcing sheet, the reinforcing sheet has a body and an edge portion around the body, and at least one buffer portion is formed in the body.

In an embodiment, the backrest reinforcing mechanism is a reinforcing sheet, the reinforcing sheet has a body, and the body is divided into four regions, i.e., upper, lower, left, and right regions, by a vertical reference line and a horizontal reference line, and one or more buffer portions are arranged in each region.

In an embodiment, the backrest reinforcing mechanism is a reinforcing sheet, a lower edge of the reinforcing sheet is further provided with a clamping portion, and a shape of the clamping portion is matched with that of a connecting hook at a lower end of the backrest portion, and the clamping portion has an open hole, wherein a limiting bulged rib is arranged on a surface of the connecting hook facing the clamping portion, and the limiting bulged rib passes through the open hole corresponding arranged in the clamping portion, so as to position the clamping portion on the connecting hook.

In an embodiment, the backrest reinforcing mechanism is a reinforcing sheet, the reinforcing sheet has a body and a clamping portion connected to a lower end of the body, and a wall thickness of the clamping portion is greater than or equal to that of the body.

In an embodiment, the clamping portion is integrally formed with the body, and a wall thickness of the reinforcing sheet ranges from 1.2 mm to 1.8 mm.

In an embodiment, the clamping portion is fixed to the body by welding, and the wall thickness of the clamping portion is greater than that of the body.

In an embodiment, the wall thickness of the body ranges from 1.2 mm to 1.5 mm, and the wall thickness of the clamping portion ranges from 1.6 mm to 2 mm.

In an embodiment, the backrest reinforcing mechanism has a body, at least one buffer portion is formed in the body, and a region occupied by the buffer portion is substantially symmetrically distributed on a surface of the body.

A child safety seat is provided according to the disclosure. The child safety seat includes: a seat portion; a backrest portion, arranged above the seat portion; and the backrest reinforcing mechanism according to the disclosure.

In an embodiment, the child safety seat further includes: two side wing portions, respectively arranged on two sides of the backrest portion and above a seat portion armrest of the seat portion; and a headrest arranged on an upper portion of the backrest portion.

In an embodiment, a connecting hook with a locking hole is correspondingly arranged on a lower side of the backrest portion, and the backrest reinforcing mechanism is respectively inserted into the corresponding locking hole to be fixed on the backrest portion.

In an embodiment, a concave portion is arranged on two sides of a rear part of the seat portion, a clamping rod is arranged in the concave portion, and the clamping rod and the concave portion enclose a clamping port; a backrest body of the backrest portion is located above the clamping rod, and the connecting hook of the backrest portion firstly extends downward from a lower side of the backrest body, such that when the backrest portion is installed on the seat portion, the connecting hook is able to penetrate into the clamping port, and bypass the clamping rod, and a connecting hook extension at a free end of the connecting hook is able to extend backward from the backrest portion.

In an embodiment, a limiting bulged rib is arranged on a surface of the connecting hook facing the seat portion, so as to position the backrest reinforcing mechanism.

A connecting assembly for a child safety seat is provided according to the disclosure. The connecting assembly includes: a connector body, connected to a shoulder harness and an adjusting strap of the child safety seat; and a stopper, detachably connected to the connector body and being able to cover a detachment opening of the shoulder harness to prevent the shoulder harness from separating away.

In an embodiment, the stopper has a stopper body and a separation preventing portion, the stopper body is detachably connected to the connector body, and the separation preventing portion is cooperatively fixed to the connector body, so as to prevent the connector body from separating away.

In an embodiment, connector body includes: a main body portion, for connecting to the adjusting strap; and an extension portion, connected to the main body portion, the extension portion defines a shoulder harness connection hole and a shoulder harness detachment opening with the main body portion, the shoulder harness connection hole is used for connecting to the shoulder harness, and the shoulder harness detachment opening is communicated with the shoulder harness connection hole and used for detaching the shoulder harness.

In an embodiment, the main body portion is provided with an adjusting strap connection hole, and the adjusting strap connection hole is used for connecting to the adjusting strap.

In an embodiment, the extension portion extends transversely with respect to the main body portion, the extension portion has a protruding portion at an end thereof, and the protruding portion and the main body portion define the shoulder harness connection hole and the shoulder harness detachment opening.

In an embodiment, the separation preventing portion is configured as a hook, and the hook is arranged on an end side of the stopper body and detachably connected to the protruding portion of the extension portion.

In an embodiment, the hook is clamped into the shoulder harness connection holes at the shoulder harness detachment opening, and abuts against an engaging surface of the protruding portion facing the extension portion.

In an embodiment, the separation preventing portions is configured as a buckles, a side surface of the end of the extension portion is provided with a corresponding clamping recess, and the buckle is detachably clamped with the clamping recess.

In an embodiment, one of the buckle and the clamping recess is provided with a fixing convex, and the other is provided with a fixing concave cooperating with the fixing convex.

In an embodiment, the separation preventing portion is configured as a fixing convex protruding from front and rear side walls of the stopper body to opposite side walls, and the end is provided with a fixing concave cooperating with the fixing convex; and/or the separation preventing portion is configured as a fixing concave recessed from front and rear walls of the stopper body away from the opposite side walls, and the end is provided with a fixing convex cooperating with the fixing concave.

In an embodiment, the stopper is provided with a recessed portion at a position corresponding to the shoulder harness detachment opening, and the recessed portion is clamped into the shoulder harness detachment opening.

In an embodiment, the stopper body is fixedly connected to the main body portion of the connector body.

In an embodiment, the stopper body extends towards both ends in a longitudinal direction to form the separation preventing portion.

In an embodiment, the stopper body is connected to the main body portion through a fixing portion.

In an embodiment, the stopper body is pivotably connected to the main body portion of the connector body.

In an embodiment, the stopper body extends towards a free end in a longitudinal direction to form the separation preventing portion.

In an embodiment, the stopper body is connected to the main body portion through a pivoting coupler.

In an embodiment, the stopper is configured as a sheet for connecting to the connector body and covering the detachment opening.

In an embodiment, the stopper has an inner surface for engaging with the connector body to prevent the stopper from being detached from the connector body.

In an embodiment, material engaging is bonding or welding.

A child safety seat is also provided according to the disclosure. The child safety seat includes: the connecting assembly according to the disclosure; a seat part; a backrest portion, connected to the seat part; an adjusting strap, connected to the connecting assembly and the seat part; and a shoulder harness, connected to the connecting assembly and the backrest portion.

In an embodiment, the child safety seat is provided with an accommodating recess for accommodating the connecting assembly.

In an embodiment, the accommodating recess is arranged on a rear side region of the seat portion.

### BRIEF DESCRIPTION OF THE DRAWINGS

FIG. 1 is a front perspective view of a child safety seat according to a first aspect of the disclosure, in which side-impact protection blocks are in a closed state;

FIG. 2 is a front perspective view of the child safety seat according to the first aspect of the disclosure, in which one of the side-impact protection block is in a spreaded state;

FIG. 3 is a rear perspective view of the child safety seat according to the first aspect of the disclosure, in which the side-impact protection blocks are in a closed state;

FIG. 4 is a rear lower perspective view of the child safety seat according to the first aspect of the disclosure, in which one of the side-impact protection blocks is in a spreaded state;

FIG. 5 is a side view of the child safety seat according to the first aspect of the disclosure, in which the side-impact protection block is in a closed state;

FIG. 6 is a side view of the child safety seat according to the first aspect of the disclosure, in which one of the side-impact protection blocks is in a spreaded state, and the other of the side-impact protection blocks is in a closed state;

FIGS. 7A, 7B, and 7C are perspective views of the side-impact protection mechanism according to the first aspect of the disclosure, and FIGS. 7D, 7E, and 7F are side views of the side-impact protection mechanism according to the disclosure;

FIG. 8 is a cross-sectional view of the side-impact protection mechanism according to the first aspect of the disclosure, in which the side-impact protection block is in a closed state;

FIG. 9 is a cross-sectional view of the side-impact protection mechanism according to the first aspect of the disclosure, in which the side-impact protection block is in an intermediate position between a closed state and a spreaded state;

FIG. 10 is a cross-sectional view of the side-impact protection mechanism according to the first aspect of the disclosure, in which the side-impact protection block is in a spreaded state;

FIG. 11 is a front perspective view of a child safety seat according to an embodiment of a second aspect of the disclosure, in which a front side of a backrest portion is provided with a front backrest reinforcing mechanism;

FIG. 12 is a rear perspective view of a backrest portion of the child safety seat according to an embodiment of the second aspect of the disclosure, in which a back side of the backrest portion is not provided with cover plate;

FIG. 13 is a rear perspective view of the backrest portion of the child safety seat according to an embodiment of the second aspect of the disclosure, in which a back side of the backrest portion is provided with cover plate;

FIG. 14 shows a seat portion according to an embodiment of the second aspect of the disclosure;

FIG. 15 is a front side view of a front backrest reinforcing mechanism according to an embodiment of the second aspect of the disclosure;

FIG. 16 is a rear side view of the front backrest reinforcing mechanism shown in FIG. 15;

FIG. 17 is a front side view of the front backrest reinforcing mechanism according to another embodiment of the second aspect of the disclosure;

FIG. 18 is a front side view of the front backrest reinforcing mechanism according to another embodiment of the second aspect of the disclosure;

FIG. 19 is a front side view of the front backrest reinforcing mechanism according to another embodiment of the second aspect of the disclosure;

FIG. 20 is a front side view of the front backrest reinforcing mechanism according to another embodiment of the second aspect of the disclosure;

FIG. 21 is a front perspective view of a backrest portion of a child safety seat according to another embodiment of the second aspect of the disclosure;

FIG. 22 is an exploded perspective view of the backrest portion and the front backrest reinforcing mechanism shown in FIG. 11 of the child safety seat according to another embodiment of the second aspect of the disclosure;

FIG. 23 is a front view of the front backrest reinforcing mechanism according to another embodiment of the second aspect of the disclosure;

FIG. 24 is a front perspective view of a child safety seat according to an embodiment of the second aspect of the disclosure, in which a front side of the backrest portion is provided with a front backrest reinforcing mechanism different from that shown in FIG. 1;

FIG. 25 is a front side view of the front backrest reinforcing mechanism adopted in FIG. 24;

FIG. 26 is a rear side view of the front backrest reinforcing mechanism adopted in FIG. 24;

FIG. 27 is a rear perspective view of a backrest portion of a child safety seat according to an embodiment of the second aspect of the disclosure, in which a back side of the backrest portion is provided with cover plates;

FIG. 28 is a perspective view of a rear backrest reinforcing mechanism according to an embodiment of the second aspect of the disclosure;

FIG. 29 is a perspective view of the rear backrest reinforcing mechanism shown in FIG. 28, in which one of the second rods is removed to facilitate showing an internal structure;

FIG. 30 is a front view of a locking rod of the rear backrest reinforcing mechanism according to the second aspect of the disclosure;

FIGS. 31A and 31B respectively show portionially exploded perspective views of the rear backrest reinforcing mechanism according to the second aspect of the disclosure;

FIG. 32 is a perspective view of a rear backrest reinforcing mechanism according to another embodiment of the second aspect of the disclosure;

FIG. 33 is a rear perspective view of a child safety seat according to an embodiment of the second aspect of the disclosure, in which the back side of the backrest portion is provided with a rear backrest reinforcing mechanism;

FIG. 34 is a rear perspective view of the child safety seat shown in FIG. 33 in another angle;

FIG. 35 shows the rear backrest reinforcing mechanism of the child safety seat shown in FIG. 34 in an unlocked state during installation or disassembly;

FIG. 36 shows a child safety seat according to a third aspect of the disclosure;

FIG. 37 is a side view of a connecting assembly according to a first embodiment of the third aspect of the disclosure;

FIG. 38 is a perspective view of a connecting assembly according to the first embodiment of the third aspect of the disclosure;

FIG. 39 is an exploded perspective view of the connecting assembly according to the first embodiment of the third aspect of the disclosure;

FIG. 40 is a perspective view of a stopper according to the first embodiment of the third aspect of the disclosure;

FIG. 41 is a front perspective view of the connecting assembly according to a second embodiment of the third aspect of the disclosure;

FIG. 42 is a side perspective view of the connecting assembly according to the second embodiment of the third aspect of the disclosure connecting assembly;

FIG. 43 is a front perspective view of a connecting assembly according to a third embodiment of the third aspect of the disclosure;

FIG. 44 is a side perspective view of the connecting assembly according to the third embodiment of the third aspect of the disclosure connecting assembly;

FIG. 45 is a front perspective view of a connecting assembly according to the third embodiment of the third aspect of the disclosure, in which the stoppers are opened;

FIG. 46 is a side perspective view of the connecting assembly according to the third embodiment of the third aspect of the disclosure, in which the stoppers are opened;

FIG. 47 is a portionial sectional view of the connecting assembly according to the third embodiment of the third aspect of the disclosure;

FIG. 48 is an exploded perspective view of the connecting assembly according to the third embodiment of the third aspect of the disclosure;

FIG. 49 is a perspective view of a connecting assembly according to a fourth embodiment of the third aspect of the disclosure, in which the stoppers are opened;

FIG. 50 is a side view of a connecting assembly according to a fifth embodiment of the third aspect of the disclosure;

FIG. 51 is an exploded perspective view of connecting assembly according to the fifth embodiment of the third aspect of the disclosure connecting assembly;

FIG. 52 is a side view of a connecting assembly according to a sixth embodiment of the third aspect of the disclosure;

FIG. 53 is an exploded perspective view of the connecting assembly according to the sixth embodiment of the third aspect of the disclosure;

FIG. 54 is a side view of a connecting assembly according to a seventh embodiment of the third aspect of the disclosure; and

FIG. 55 is an exploded perspective view of the connecting assembly according to the seventh embodiment of the third aspect of the disclosure.

### DETAILED DESCRIPTION

Although the present invention will be illustrated and described herein with reference to specific embodiments, it should not be limited to the details shown. Specifically, various modifications may be made to these details within the scope of equivalents of the claims without departing from the invention.

The descriptions about directions such as “front,” “back,” “upper,” and “lower” related herein are only for the convenience of understanding. The invention is not limited to these directions, rather, it can be adjusted according to the actual situation. Although the disclosure is described with reference to typical embodiments, the terminology used is illustrative and exemplary, rather than restrictive.

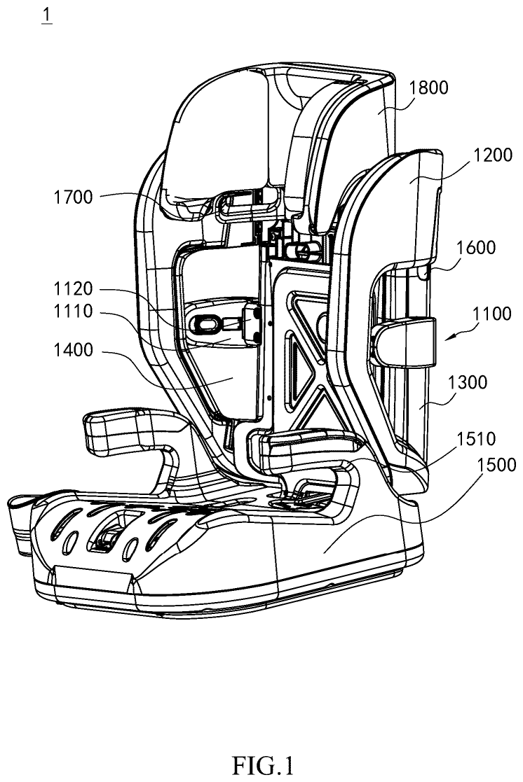

In a first aspect of the disclosure, a child safety seat 1 according to the disclosure will be wholly described by referring to FIGS. 1 to 6. The child safety seat 1 includes side-impact protection mechanisms 1100, side wings 1200, a backrest 1300, a seat 1500, and a pillow 1800. Generally, regarding a binding path of a car-mounted safety belt, the child safety seat 1 has a Harness mode and a Booster mode, and the binding path will be specifically described for the embodiments below.

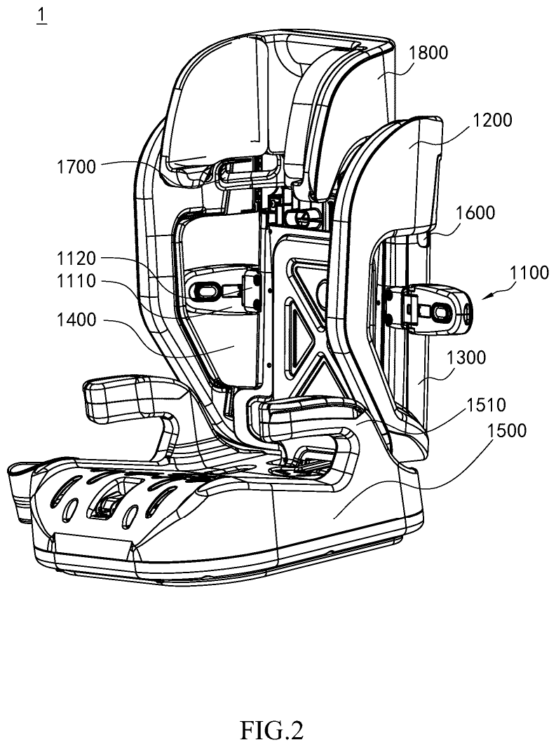

More specifically, FIGS. 1 and 2 show front perspective views of the child safety seat 1 according to the disclosure, in which the side-impact protection blocks 1110 of the two side-impact protection mechanisms 1100 in FIG. 1 are in a closed state, and one side-impact protection block 1110 in FIG. 2 is in a spreaded state.

According to this embodiment, the child safety seat 1 includes a seat 1500 with seat armrests 1510 for a child to sit on. A backrest 1300 is disposed above the seat 1500, and the backrest 1300 can be interconnected with the seat 1500. The pillow 1800 is arranged at an upper portion of the backrest 1300, and can be moved up and down with respect to the backrest 1300. The pillow 1800 includes a pillow rear and pillow wings. A guide 1700 is arranged at the backrest 1300 between the pillow wing and the side wing 1200 of the child safety seat 1. The guide 1700 is arranged at a lower end of each pillow wing. The guides 1700 are used to guide shoulder harness of the car-mounted safety belt (not shown) in the Booster mode of the child safety seat 1. In this embodiment, two sides of the child safety seat 1 are each provided with a guide 1700, such that the child safety seat 1 can be installed on left and right sides of a back seat of a car, which is convenient for installation and use.

Two sides of the backrest 1300 are each provided with a side wing 1200. The side wings, for example, are located above the seat armrests 1510 of the seat 1500. The side wings 1200 protrude forward on both sides of the backrest 1300, and an opening 1400 is defined by the side wing 1200. In this embodiment, the side wing 1200 and side edge of the backrest 1300 together define the opening 1400. In connections of the backrest 1300 and the side wing 1200, two sides of an upper back portion of the backrest 1300 are each provided with a gripper 1600 for gripping the shoulder harness of the car-mounted safety belt in the Harness mode.

The child safety seat 1 according to the disclosure includes the side-impact protection mechanism 1100, and in this embodiment, two side-impact protection mechanisms 1100 are respectively arranged on two sides of the backrest 1300. Each of the side-impact protection mechanisms 1100 according to the disclosure has a side-impact protection block 1110 and a fixed base 1120, and the fixed base 1120 is pivotably connected to the side-impact protection block 1110 and fixedly installed on a backrest side of the opening 1400 by two screws respectively on both sides. The side-impact protection block 1110 has a spreaded state and a closed state. In the closed state shown in FIG. 1, the side-impact protection block 1110 is located in the middle of a corresponding opening 1400, and divides the opening 1400 into upper and lower portions which are preferably not communicated to each other. That is, after the side-impact protection blocks 1110 are closed, the side-impact protection blocks 1100 are basically attached to the side wings 1200. In the spreaded state shown in FIG. 2, the side-impact protection block 1100 protrudes laterally from a side of the backrest 1300 to improve a side-impact protection effect of the child safety seat 1. In such case, the side-impact protection blocks 1110 will not obstruct the opening 1400, so the car-mounted safety belt can correctly pass through the opening 1400.

Generally, a car-mounted safety belt for the child safety seat 1 has a shoulder harness and a waistbelt. According to the binding path of car-mounted safety belt of the disclosure, in the Harness mode, when the side-impact protection block 1110 on a side close to a door is in the spreaded state, the shoulder harness of the car-mounted safety belt can sequentially pass through the gripper 1600 arranged at a connection of the backrest 1300 and the side wing 1200 on the side close to the door, and an upper portion of the opening 1400 on the side close to the door, while the waistbelt of the car-mounted safety belt passes through a lower portion of the opening 1400 on the side close to the door, and then passes through a lower portion of the opening 1400 of the backrest 1300 on a side away from the door together with the shoulder harness, so as to be inserted into and fixed with a safety belt buckle on a car seat. In the Booster mode, the shoulder harness of the car-mounted safety belt sequentially passes through a guide 1700 which is arranged between the backrest 1300 and the pillow 1800 and close to the side of the door, and passes under an armrest 1510 on the side away from the door, while the waistbelt of the car-mounted safety belt passes under an armrest 1510 on the side close to the door, and then passes under the armrest 1510 on the side away from the door together with the shoulder harness, so as to be inserted into and fixed with a safety belt buckle on the car seat.

Referring to FIG. 1, since in the Harness mode, the shoulder harness of the car-mounted safety belt has to pass through the gripper 1600 and then through two openings 1400, and the waistbelt only passes through the two openings, if a side-impact protection block 1110 is not spreaded, the side-impact protection block 1110 will obstruct the corresponding opening 1400, such that the car-mounted safety belt cannot be installed and fixed correctly. At this time, the side-impact protection block 1110 close to a side of the door needs to be actively spreaded, then the car-mounted safety belt or adult safety belt can be installed, so as to play a role of actively preventing misuse of the side-impact protection mechanisms 1100. That is to, a side-impact protection mechanism 1100 according to the disclosure is arranged on a side of the backrest to divide the openings 1400 through which the car-mounted safety belt passes, i.e., the side-impact protection block 1110 is abutted against or attached to the side wing 1200 when in the closed state, so the user can easily find that the side-impact protection block 1110 is in the closed state and cannot achieve the purpose of preventing side-impact.

As shown in FIG. 2, a side-impact protection block 1110 is in a spreaded state, and the side-impact protection block 1110 protrudes laterally on a side of the backrest 1300 without obstructing the corresponding opening 1400, such that the car-mounted safety belt can pass through the opening 1400. Meanwhile, the side-impact protection block 1110 in the spreaded state plays a role of preventing side-impact.

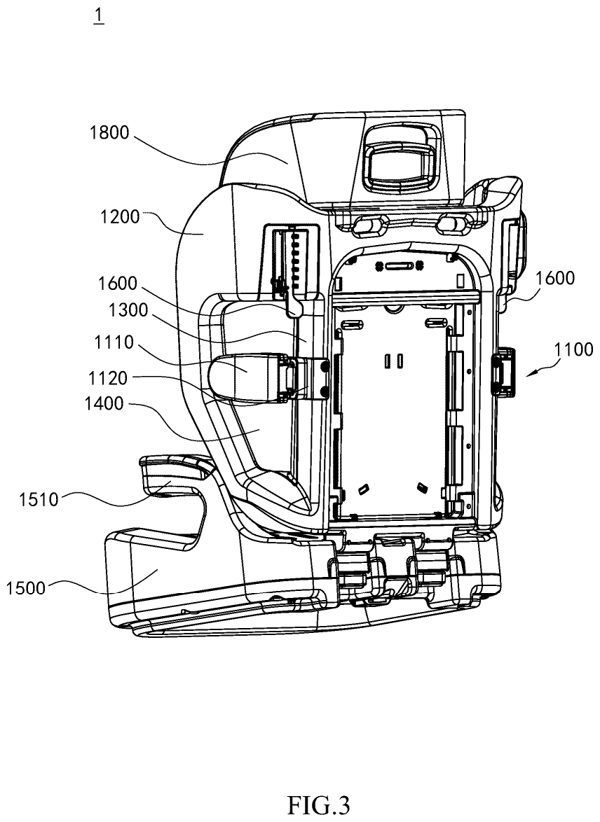

FIG. 3 is a rear perspective view of the child safety seat 1 according to the disclosure, in which the side-impact protection block 1110 is in a closed state. Corresponding to FIG. 1, the side-impact protection block 1110 on the left side of FIG. 3 is fixedly arranged on a side of the backrest and divides an opening 1400 into upper and lower portions. The side-impact protection block 1110 in the closed state creates an obstruct at the opening 1400, such that the car-mounted safety belt cannot be correctly installed and fixed. FIG. 3 also shows in detail that in connections of the backrest 1300 and the side wings 1200, two sides of an upper back portion of the backrest 1300 are each provided with a gripper 1600, such that the child safety seat 1 can be installed on left and right sides of a back seat of a car, which is convenient for installation and use.

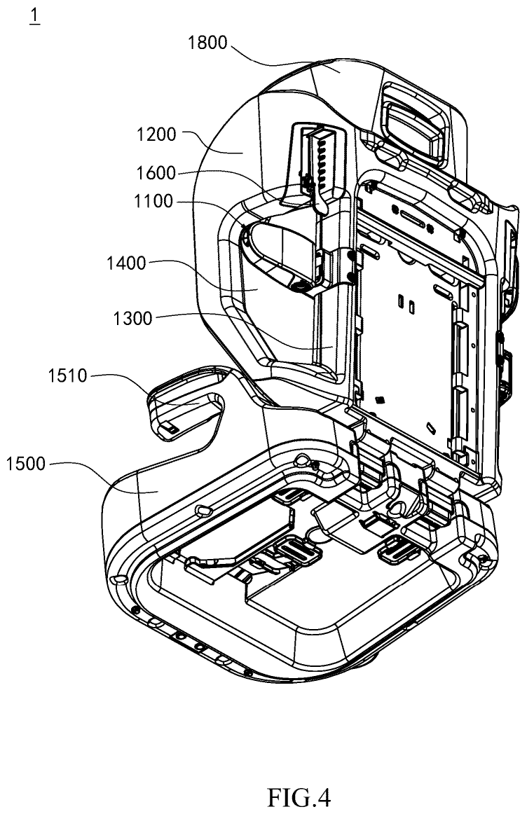

FIG. 4 is a rear lower perspective view of the child safety seat 1 according to the disclosure. Corresponding to FIG. 2, the side-impact protection block 1110 on the left side of FIG. 4 is in a spreaded state, and in this spreaded state, a car-mounted safety belt can be correctly installed without obstacles.

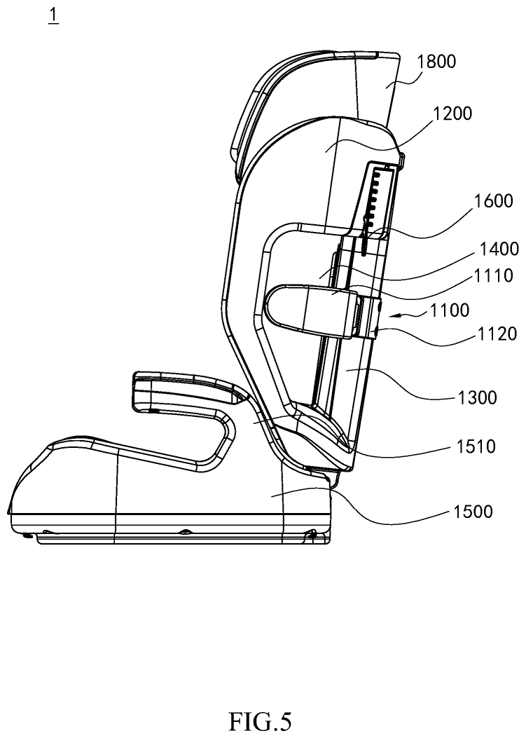

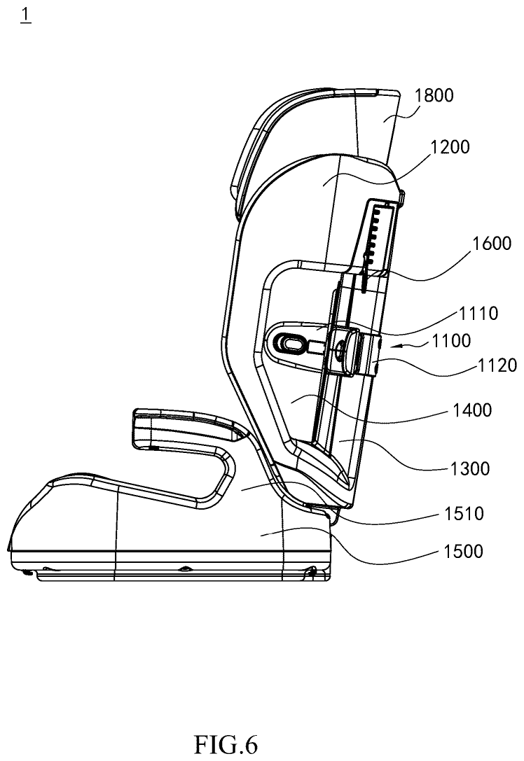

FIGS. 5 and 6 are side views of the child safety seat 1 according to the disclosure, in which the side-impact protection block 1110 in FIG. 5 is in the closed state, while in FIG. 6, one side-impact protection block 1110 is in a spreaded state, and the other side-impact protection block 1110 is in a closed state. In the side views, the fixed bases 1120 of the side-impact protection mechanisms 1100 are substantially fixed on the sides of the backrest 1300 in the middle of the backrest 1300, and the fixed base 1120 is clamped between a front side and a rear side of the backrest 1300, especially on a side of the backrest.

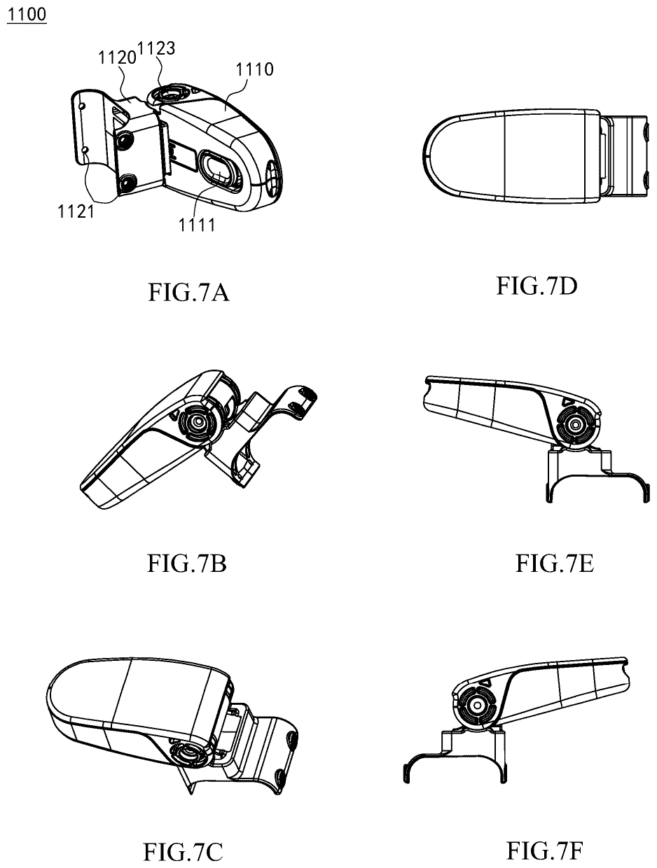

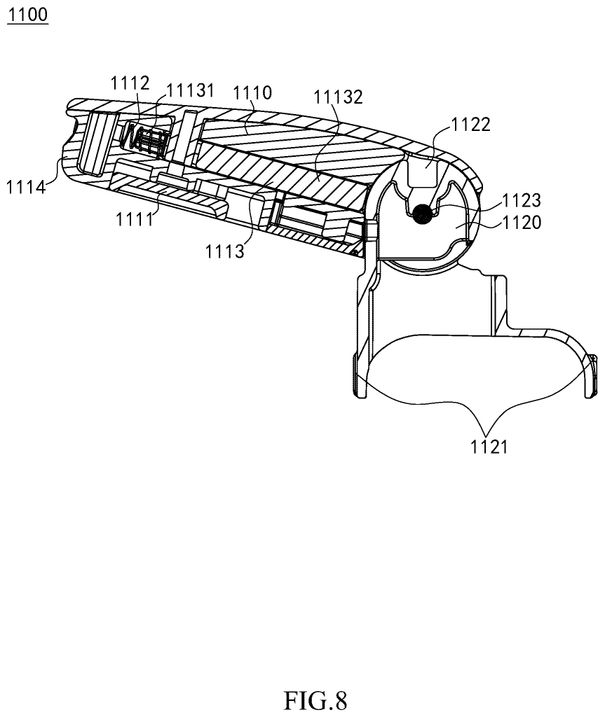

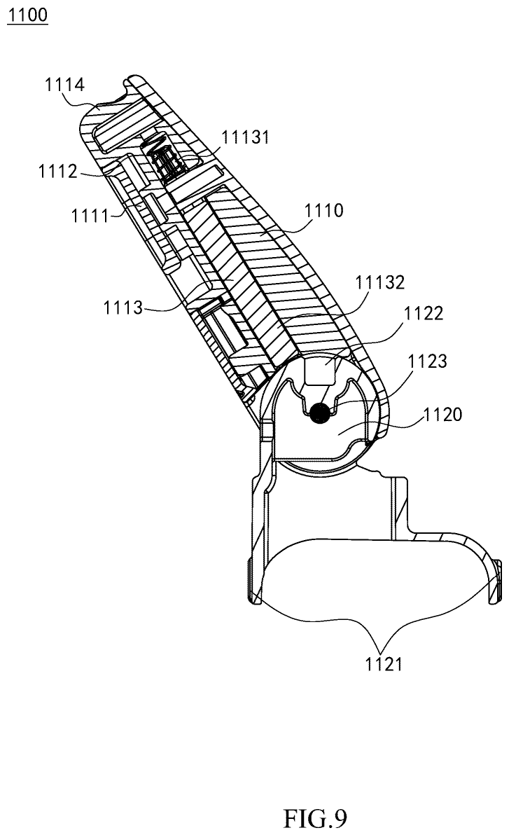

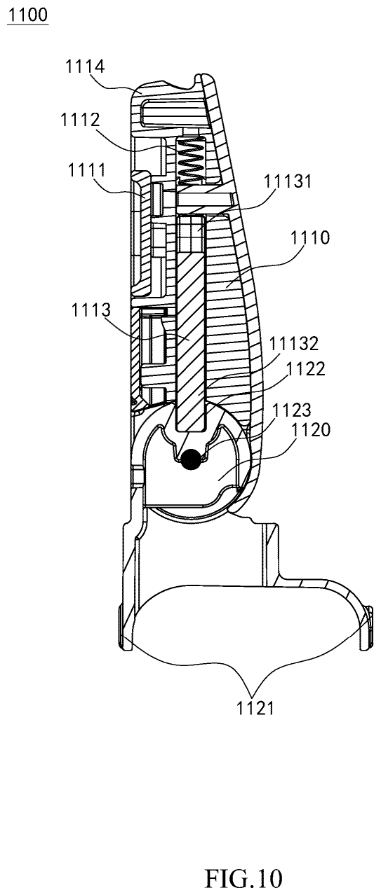

FIGS. 7 to 10 show a side-impact protection mechanism 1100 according to the disclosure, in which FIGS. 7A, 7B, and 7C are perspective views of the side-impact protection mechanism 1100 according to the disclosure, FIGS. 7D, 7F, 7E, and 7F are side views of the side-impact protection mechanism 1100 according to the disclosure, FIG. 8 is a cross-sectional view through the side-impact protection mechanism 1100 according to the disclosure, in which the side-impact protection block 1110 is in a closed state, FIG. 9 is a cross-sectional view through the side-impact protection mechanism 1100 according to the disclosure, in which the side-impact protection block 1110 is in an intermediate position between the closed state and the spreaded state, and FIG. 10 is a cross-sectional view through the side-impact protection mechanism 1100 according to the disclosure, in which the side-impact protection block 1110 is in a spreaded state.

The perspective views of FIGS. 7A, 7B, and 7C and the side views of FIGS. 7D, 7E, and 7F show the side-impact protection mechanism 1100 according to the disclosure from different angles. In this embodiment, the side-impact protection mechanism 1100 has the side-impact protection block 1110 and the fixed base 1120, and the fixed base 1120 is pivotably connected to the side-impact protection block 1110. In addition, as shown in the drawings, in order to be clamped and fixed on the front side and the back side of the backrest 1300, the fixed base 1120 has corresponding mounting holes 1121, such as screw holes. There are two screw holes respectively on both sides of the fixed base 1120 for screws to pass through to be connect to and fixed with the backrest 1300.

FIGS. 8, 9, and 10 show an exemplary concrete structure of the side-impact protection mechanism 1100 in cross-sectional views, and sequentially show the closed state (FIG. 8), the intermediate position between the closed state and the spreaded state (FIG. 9), and the spreaded state (FIG. 10) of the side-impact protection block 1110. It can be seen from this embodiment, a housing 1114 of the side-impact protection block 1110 is pivotably arranged on a pivoting portion 1123 of the fixed base 1120. The side-impact protection block 1110 has a knob 1111 disposed on an inner side facing the child safety seat 1. The knob 1111 is slidably installed inside the housing 1114, and exposed outside the housing 1114 for operation. A clamping block 1113 and a spring 1112 are also arranged inside the housing 1114. The clamping block 1113 can slide in the housing 1114 and is fixedly connected to the knob 1111, and has a mounting end 11131 away from the fixed base 1120 and a clamping end 11132 close to the fixed base 1120, wherein the spring 1112 arranged between an inner wall of the housing 1114 and the mounting end 11131 of the clamping block 1113 cooperates with the mounting end 11131, so as to exert a force to push the clamping end 11132 of the clamping block 1113 out of the housing 1114.

The pivoting portion 1123 of the fixed base 1120 is provided with a clamping hole 1122 that is open outwardly. In the closed state (FIG. 8) and the intermediate position (FIG. 9), the clamping end 11132 of the clamping block 1113 abuts against an outer circumference of the pivoting portion 1123, and retracts into the housing 1114. In the spreaded state (FIG. 10), with the help of the force of the spring 1112, the clamping end 11132 of the clamping block 1113 protrudes from the housing 1114 and clamped into the clamping hole 1122 of the fixed base 1120, such that the side-impact protection block 1110 is always kept in the spreaded state.

In order to fold the side-impact protection block 1110 from the spreaded state to the closed state, the user can push the knob 1111 to overcome the force of the spring 1112, and the knob brings the clamping block 1113 to retract into the housing 1114 so as to be released from clamping of the clamping hole 1122. A torsion spring (not shown) is arranged between the housing 1114 and the pivoting portion 1123, and the torsion spring is adapted to exert a force to pivot the side-impact protection block 1110 to the closed state, and is adapted to keep the side-impact protection block 1110 in the closed state.

To sum up, by arranging the side-impact protection block 1110 on a side of the backrest, and making the side-impact protection block 1110 be abutted against one of the side wings 1200 while in the closed state in order to obstruct the opening 1400 between the side wing 1200 and the backrest 1300, the car-mounted safety belt cannot be passed through the opening correctly, i.e., the car-mounted safety belt cannot be installed correctly, if the side-impact protection block 1110 is not spreaded when the car-mounted safety belt is passed through, so as to remind the user to spread the side-impact protection block 1110 in order to ensure a side-impact protection effect.

The disclosure solves the technical problem that the user may forget to spread the side-impact protection block 1110.

Only by actively spreading the side-impact protection block 1110 can the car-mounted safety belt be correctly installed, thus realizing an active misuse prevention function, improving the safety of the child safety seat 1 in use, and playing a better protection role for children.

According to the second aspect of the disclosure, by arranging a backrest reinforcing mechanism on the backrest portion of the child safety seat, the strength of the backrest portion can be enhanced and the deformation amount thereof can be reduced, so as to reduce the horizontal displacement of the head during impact. The reinforcing mechanism may have a sheet-like or plate-like structure, and its shape is arranged to be matched with the shape of the backrest, furthermore, the reinforcing mechanism may be fixed to the backrest by screw(s). In addition, the reinforcing mechanism may be a reinforcing bracket, and the reinforcing bracket may be arranged on a back side of backrest portion and its lower end may be movably inserted into the backrest portion, so as to limit the backrest portion, thereby reducing deformation of the backrest portion, and further reducing the horizontal displacement of the head during impact.

When the reinforcing mechanism has a sheet-like or plate-like structure, it may be a metal plate or a metal sheet, and it may have various shapes, but the invention is not limited thereto. Moreover, by the specific structure of the reinforcing bracket and the limit structure between the reinforcing bracket and the backrest, etc., the disclosure solves the problem of excessive horizontal displacement of the head, especially in the Harness mode.

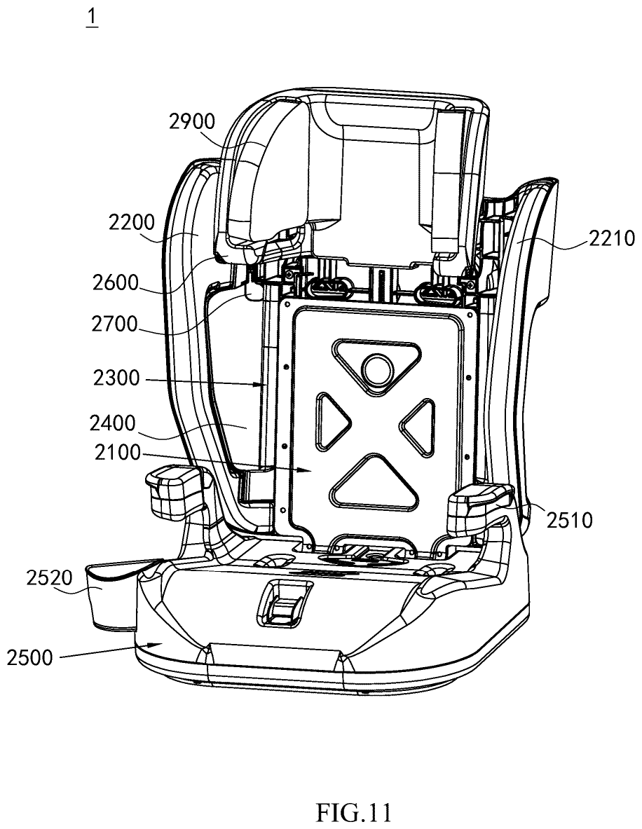

FIG. 11 is a front perspective view of the child safety seat 1 according to an embodiment of the disclosure. The child safety seat 1 includes a backrest portion 2300, a seat portion 2500, and a backrest reinforcing mechanism 2100. In this embodiment, a front side of the backrest portion 2300 is provided with a front backrest reinforcing mechanism 2100.

According to this embodiment, the seat portion 2500 includes seat portion armrests 2510 and is used for seating a child. The seat portion 2500 is further provided with a cup holder 2520 on a side. The backrest portion 2300 is arranged above the seat portion 2500, and the backrest portion 2300 and the seat portion 2500 may be detachably connected to each other. In another embodiment, the backrest portion 2300 may be fixedly connected to the seat portion 2500.

The child safety seat 1 further includes a headrest 2900. The headrest 2900 is arranged at an upper portion of the backrest portion 2300, and can move up and down with respect to the backrest portion 2300. A guide 2600 is arranged between the headrest 2900 and the backrest portion 2300. The guide 2600 is used for guiding the shoulder harness of the car-mounted safety belt (not shown) in the Booster mode of the child safety seat 1.

A side wing portion 2200 with a side wing foam 2210 are respectively disposed on both sides of the backrest portion 2300, and the side wing portions 2200 are located above the seat portion armrests 2510 of the seat portion 2500, for example. The side wing portions 2200 protrude respectively forward from both sides of the backrest portion 2300, and openings 2400 for the car-mounted safety belt to pass through are defined by the side wing portions 2200. In this embodiment, the side wing portions 2200 and side edges of the backrest portion 2300 jointly define the openings 2400. In connections the backrest portion 2300 and the side wing portions 2200, two sides of an upper back portion of the backrest portion 2300 are each provided with a gripper 2700 for gripping the shoulder harness of the car-mounted safety belt in the Harness mode.

In the Harness mode, the shoulder harness of the car-mounted safety belt sequentially passes through the gripper 2700 arranged at a connection of the backrest portion 230 and the side wing portion 22000 of the child safety seat 1, and an upper portion of the opening 2400 for the car-mounted safety belt to pass through near the backrest portion 2300 and on a side close to a door, while the waistbelt of the car-mounted safety belt passes through a lower portion of the opening 2400 on the side close to the door, and then passes through a lower portion of the opening 2400 near the backrest portion and on a side away from the door together with the shoulder harness, so as to be inserted into and fixed with the safety belt buckle on a car seat. In the Booster mode, the shoulder harness of the car-mounted safety belt sequentially passes through the guide 2600 arranged between the backrest portion 2300 and the headrest 2900, and passes under the seat portion armrests 2510 on the side away from the door, while the waistbelt of the car-mounted safety belt passes under the seat portion armrests 2510 on the side close to the door, and then passes under the seat portion armrests 2510 on the side away from the door together with the shoulder harness, so as to be inserted into and fixed with the safety belt buckle on the car seat.

The front of the backrest portion 2300 is fixedly provided with a front backrest reinforcing mechanism 2100 for ensuring the strength and limiting the position of the backrest portion 2300, so as to reduce deformation amount of the backrest portion 2300 and further improve the horizontal displacement of the head during impact. The front backrest reinforcing mechanism 2100 will be explained in detail hereinbelow according to the attached drawings.

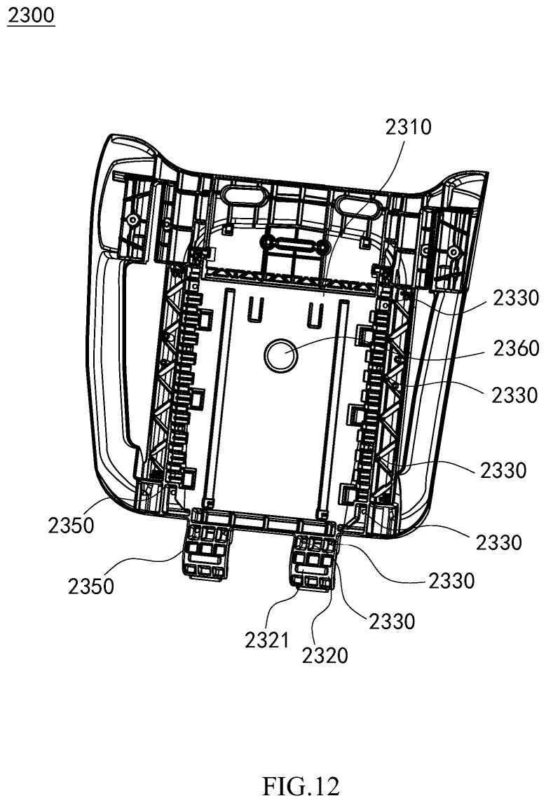

FIG. 12 is a rear perspective view of the backrest portion 2300 of the child safety seat 1 according to an embodiment of the disclosure. In this embodiment, it can be seen that there are backrest side fixing holes 2330 on a backrest body 2310 of the backrest portion 2300 and connecting hooks 2320 connected on a lower side of the backrest body 2310. The backrest body 2310 and the connecting hooks 2320 are each provided with engaging portions 2350, and the engaging portions 2350 may have different forms, such as gripping portions, bulges and the like. The connecting hooks 2320 are provided with limiting bulged ribs 2321 bulged towards the front of the backrest portion, and the limiting bulged ribs 2321 cooperates with open holes arranged in the front backrest reinforcing mechanism 2100, so as to limit or preset the position of the front backrest reinforcing mechanism 2100. The backrest body 2310 is further provided with a positioning portion 2360, such as a positioning bump bulged towards the front side of the backrest portion for positioning the front backrest reinforcing mechanism 2100.

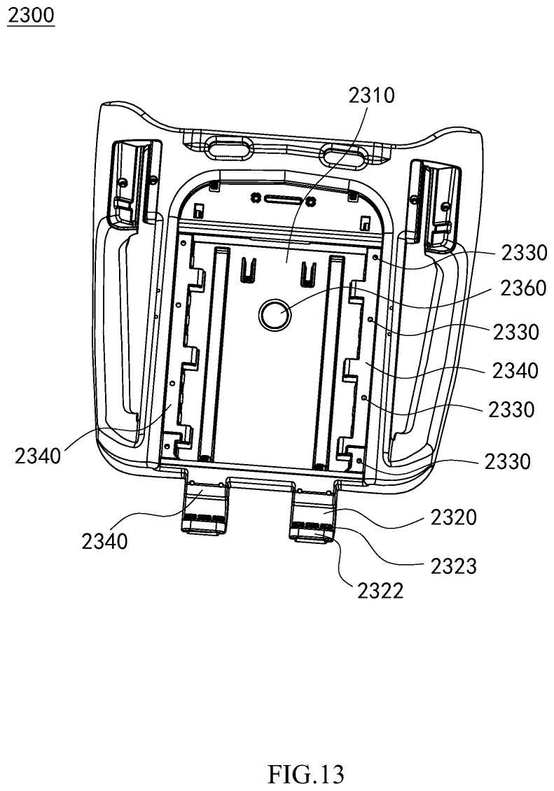

FIG. 13 is a rear perspective view of the backrest portion 2300 of the child safety seat 1 according to an embodiment of the disclosure. Different from that shown in FIG. 12, a back side of the backrest portion 2300 is provided with cover plates 2340. The cover plates 2340 cover the engaging portions 2350 by using devices corresponding to the engaging portions 2350 shown in FIG. 12 and expose the backrest side fixing holes 2330. In addition, at the connecting hooks 2320, the corresponding cover plates 2340 are fixedly connected to the front halves of the connecting hooks 2320, so as to close and form complete connecting hooks 2320.

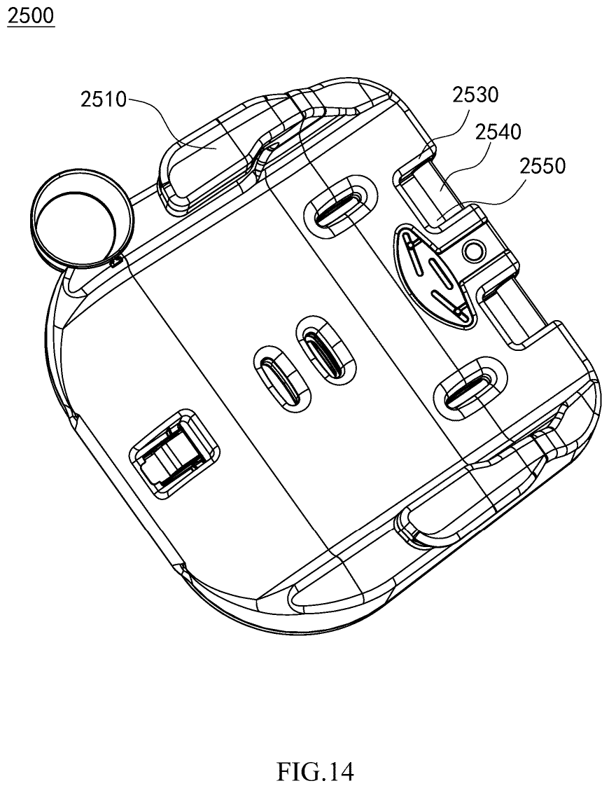

FIG. 14 shows the seat portion 2500 according to an embodiment of the disclosure. The seat portion 2500 is provided with, for example, a cup holder 2520 on the front side of the seat, and two seat portion armrests 2510 are arranged on both sides of the seat. One end of each seat portion armrest 2510 is connected to the seat portion 2500, and the other end extends to the front of the seat. In this embodiment, there are two concave portions 2530 on a rear side of the seat portion 2500, and a clamping rod 2540 is arranged in each of the concave portions 2530. The clamping rods 2540 and the concave portions 2530 enclose clamping ports 2550, and the clamping rods 2540 and the clamping ports 2550 are used for inserting and fixing of the backrest body (will be explained in detail hereinbelow according to the attached drawings).

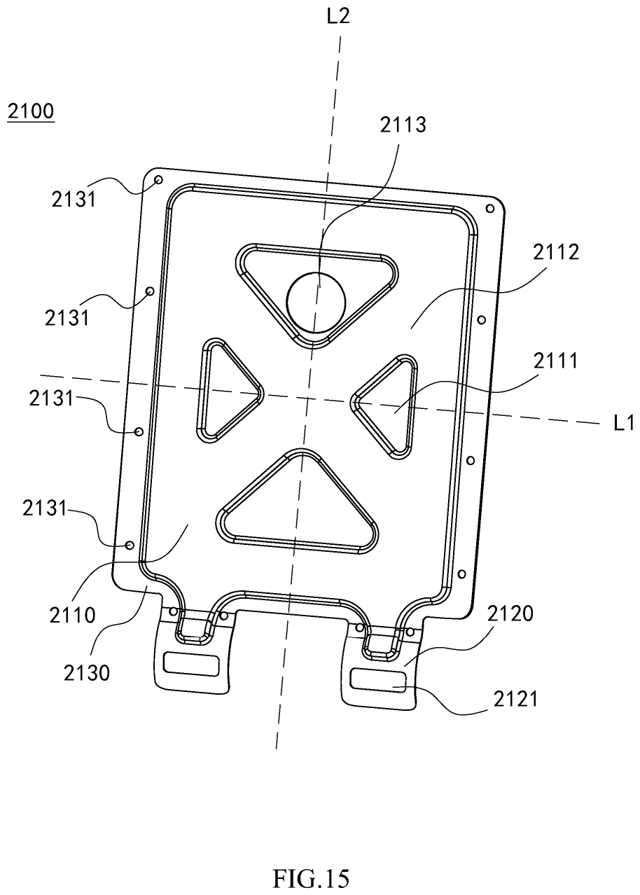

FIG. 15 is a front side view of the front backrest reinforcing mechanism 2100 according to an embodiment of the disclosure. In the illustrated embodiment, the front backrest reinforcing mechanism 2100 is fixedly arranged on the front side of the backrest portion 2300 (see FIG. 11) for ensuring the strength of the backrest portion. In this embodiment, the front backrest reinforcing mechanism 2100 is designed as a reinforcing sheet, such as a reinforcing iron sheet. However, the reinforcing sheet may be formed by other metals, such as stainless steel, aluminum alloy and the like. The front backrest reinforcing mechanism 2100 may be detachably arranged on the backrest portion 2300. For example, the shape of the reinforcing sheet is matched with that of the backrest portion 2300, and the reinforcing sheet is provided with perforations 2131 for fasteners to pass through and be fixed to fixing holes 2330 on the backrest portion 2300.

Further, fasteners, such as screws may be used to pass through the perforations 2131 in the front backrest reinforcing mechanism 2100 to be connected to and fixed with the fixing holes 2330 in the backrest portion, so as to fix the front backrest reinforcing mechanism 2100 on the backrest portion 2300. In this embodiment, the front backrest reinforcing mechanism 2100 is closely attached to the backrest portion 2300, so that the strength of the backrest portion 2300 can be further improved.

In this embodiment, the reinforcing sheet is made of a stamped metal plate, and has a body 2110 and an edge portion 2130 located around the body 2110. In this embodiment, the perforations 2131 are arranged in the edge portion 2130, but the invention is not limited thereto. Specifically, as long as the reinforcing sheet can be fixed on the backrest portion 2300 without affecting the function of the reinforcing sheet, one or more perforations 2131 may be arranged in the body 2110.

Moreover, the reinforcing sheet is also provided with clamping portions 2120 connected to the body 2110. The clamping portions 2120 are located below the body 2110, extend along the connecting hooks 2320 at the lower end of the backrest portion 2300, and arch towards the front side of the seat, but the invention is not limited thereto. The clamping portions 2120 and the backrest portion may be joined, for example, by welding, clamping and the like. As mentioned above, the surfaces of the connecting hooks 2320 facing the clamping portions 2120 are provided with limiting bulged ribs 2321, and the limiting bulged ribs 2321 pass through the open holes 2121 correspondingly arranged in the clamping portions 2120, so as to position the clamping portions 2120 on the connecting hooks 2320 and thus position the backrest reinforcing mechanism 2100 on the front side of the backrest portion 2300. The wall thickness of the clamping portions 2120 may be greater than or equal to that of the body 2110.

In an embodiment, the clamping portion 2120 is integrally formed with the body 2110, and the wall thickness of reinforcing sheet may preferably range from 1.2 mm to 1.8 mm.

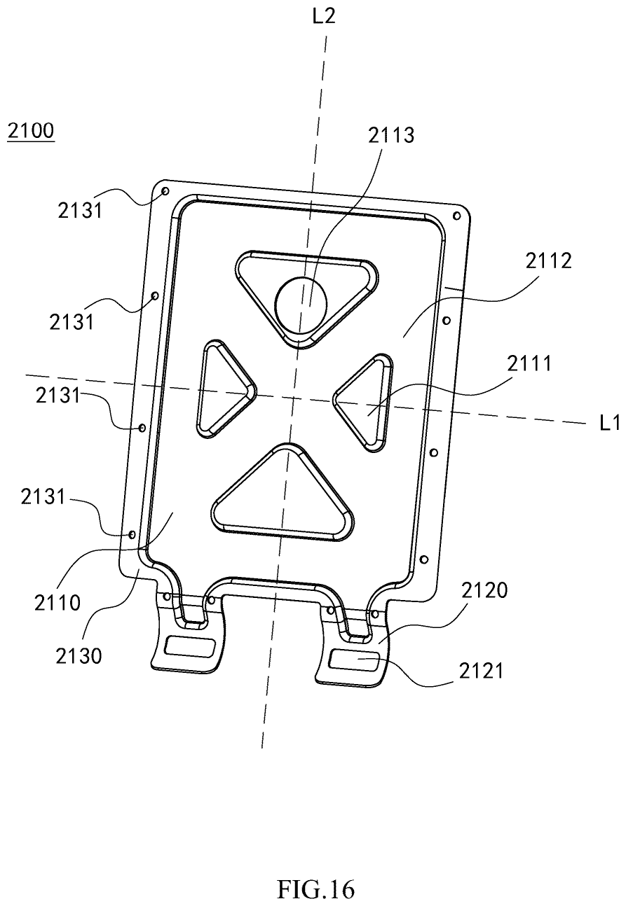

Referring to FIG. 15, in an embodiment, at least one buffer portion 2111 is formed within the body 2110. The buffer portion 2111 may be a recess formed by a front surface (i.e., the surface facing the front side of the seat portion 2500) of the reinforcing sheet (e.g., an iron sheet) being recessed inwardly. Referring to FIG. 16, FIG. 16 is a rear side view of the front backrest reinforcing mechanism 2100 shown in FIG. 15. The buffer portion 2111 is bulged from a back surface (i.e., the surface facing the backrest portion 300) of the body 2110. Different from this embodiment, the back surface of the front backrest reinforcing mechanism 2100 may also be a flat surface.

In another embodiment, the buffer portion 2111 may also be a recess formed by the back surface (i.e., the surface facing the backrest portion 2300) of the reinforcing sheet being recessed inwardly, and a bulge is formed on the front surface of the reinforcing sheet. The number and shape of the buffer portions 2111 are not limited. In this embodiment, a plurality of buffer portions 2111 are distributed on the reinforcing sheet substantially uniformly. The body 2110 may be substantially equally divided into four (upper, lower, left, right) regions by a horizontal reference line L1 and a vertical reference line L2, and one or more buffer portions 2111 can be be arranged in each region, so as to distribute the stress more uniformly.

The shape of each of the buffer portions 2111 may be symmetrically arranged and the buffer portions 2111 may have different shapes and sizes. For example, in this embodiment, the buffer portions 2111 in two adjacent regions are connected to each other so as to form a triangle, but the invention is not limited thereto. Generally, the sizes of the left and right buffer portions 2111 are smaller than the sizes of the upper and lower the buffer portions 2111.

Specifically, the region occupied by the plurality of buffer portions 2111 may be distributed on the surface of the reinforcing sheet substantially symmetrically (e.g., vertically symmetrically and/or horizontally symmetrically), and bulges 2112 are formed between these buffer portions.

In other alternative solutions of the buffer portions 2111, the wall thickness of the reinforcing sheet ranges from 1.2 mm to 1.8 mm, and a difference lies in the shape and distribution of the bulged ribs on the surface of the reinforcing sheet. In addition, the buffer portions 2111 may also be arranged to be passing through portions for passing through the body of the reinforcing sheet.

In a specific solution, the buffer portions 2111 can be bilateral symmetrically distributed on a surface of the reinforcing iron sheet in a mutually communicated way, or only one buffer portion 2111 is arranged, and the one buffer portion 2111 is composed of a plurality of sub-buffer portions mutually communicated with each other on the reinforcing sheet body. If only one buffer portion 2111 is provided, the buffer portion is also substantially point symmetrical or axisymmetric shaped, such as “X” shaped, “I” shaped (i.e., “H” flipped 90 degrees), or “H” shaped, or in a symmetrically divergent shape, so as to disperse stress. In such case, the recessed depth of the buffer portion 2111 is preferably not greater than 5 mm for ensuring sufficient strength.

According to the disclosure, when the child safety seat is impacted, the buffer portions 2111 can be deformed to produce a buffering effect, and the overall weight can be reduced.

In addition, the body 2110 of the reinforcing sheet is provided with a pre-positioning hole 2113 corresponding to the positioning portion 2360 on the backrest body 2310, so as to better position the reinforcing sheet. In this embodiment, the pre-positioning hole 2113 is arranged in an upper buffer portion. The position of the pre-positioning hole 2113 is not limited, as long as it is corresponding to the positioning bump of the backrest portion 2300. In addition, the pre-positioning hole 2113 is arranged as a through hole passing through the reinforcing sheet.

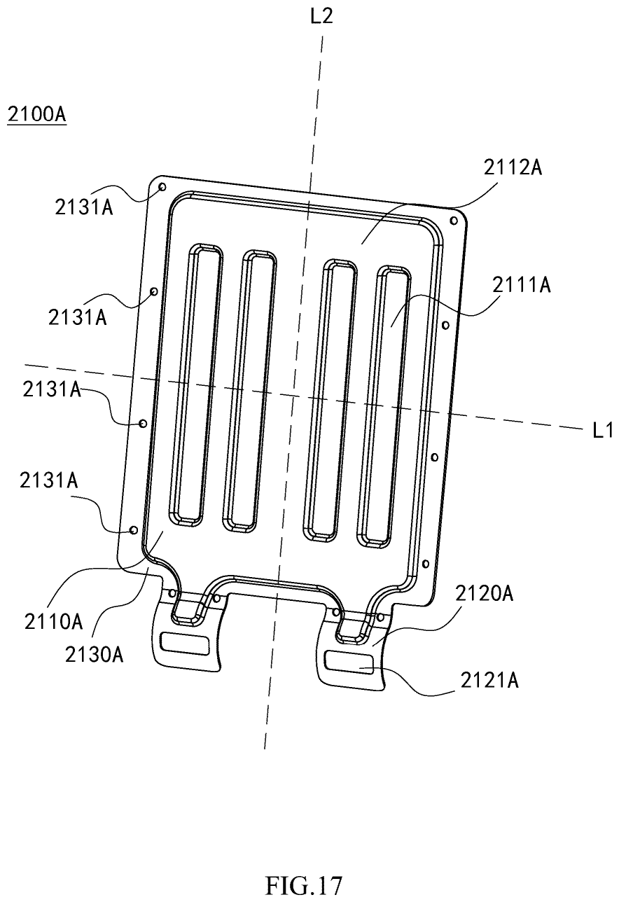

FIG. 17 is a front side view of a front backrest reinforcing mechanism 2100A according to another embodiment of the disclosure. The difference from the embodiment shown in FIG. 15 is that the buffer portions 2111A are arranged as long strip shaped buffer portions 2111A, and the four long strip shaped buffer portions 2111A are arranged symmetrically left and right on the body 110A of the reinforcing sheet. In addition, in this embodiment, no pre-positioning hole 2113 as shown in FIGS. 15 and 16 is arranged. The open holes 2121A arranged in the clamping portions 2120A can cooperate with the limiting bulged ribs 2321 on the connecting hooks of the backrest portion, so as to position the front backrest reinforcing mechanism 2100A and the backrest portion.

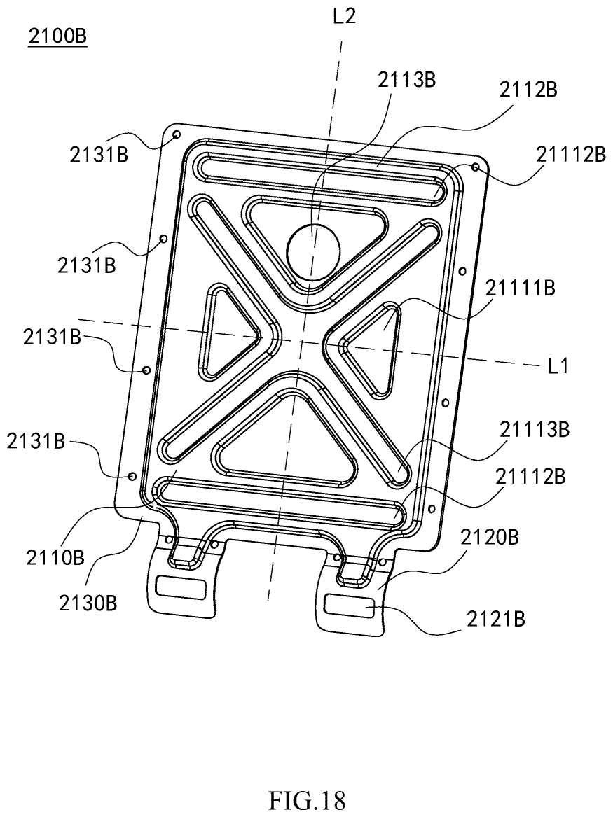

FIG. 18 is a front side view of a front backrest reinforcing mechanism 2100B according to another embodiment of the disclosure. The body 2110B may be substantially equally divided into four (upper, lower, left, right) regions by a horizontal reference line L1 and a vertical reference line L2, and one or more buffer portions 2111B may be arranged in each region, such that the stress can be dispersed more uniformly. Preferably, the distribution position of the buffer portion(s) 2111B in each region may be closer to an intermediate position of the body 2110B and farther away from a corner position. In this embodiment, the buffer portions 2111B in the two diagonal regions can be connected to each other to form an “X” shape, which can further disperse the stress at corners of the reinforcing sheet and reduce the horizontal displacement of the head during the impact.

In detail, the difference from the embodiment shown in FIG. 15 lies in that, in addition to first buffer portions 21111B, additional second buffer portions 21112B are respectively arranged on upper and lower sides of the backrest body 2110B, and a cross-shaped third buffer portion 21113B is arranged on bulges 2112B between the first buffer portions 21111B. Specifically, the first buffer portions 21111B, the second buffer portions 21112B, and the third buffer portion 21113B are respectively arranged symmetrically in pairs on the body 2110B.

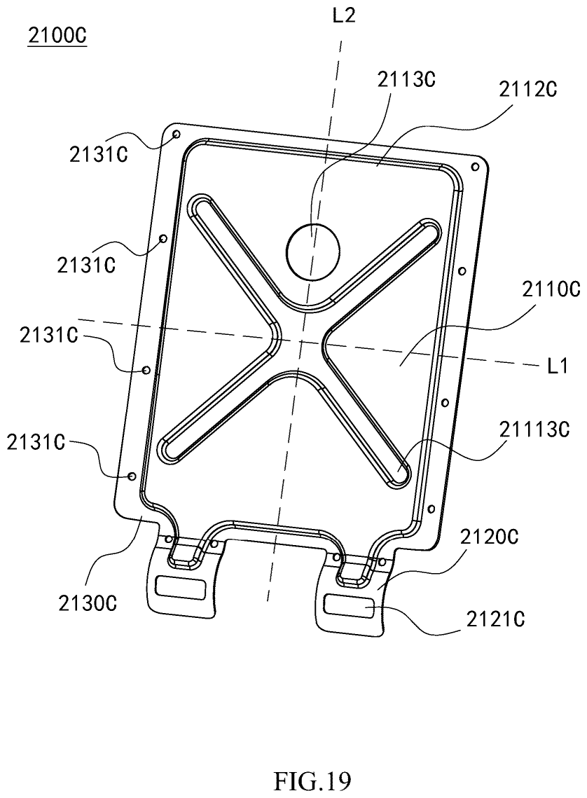

FIG. 19 is a front side view of a front backrest reinforcing mechanism 2100C according to another embodiment of the disclosure. The difference from the embodiment shown in FIG. 18 lies in that only one buffer portion 21113C is arranged on the body 2110C. However, different parts of the buffer portion 21113C are still substantially uniformly distributed in different regions of the body 2110. Further, the buffer portion 21113C may extend divergently from the middle regions to an edge portion 2130C (or a corner region). In this embodiment, the region occupied by the buffer portion 21113C is symmetrically distributed on the body 2110C. The shape of the buffer portion 1113C may be a symmetrical cross shape or an “X” shape.

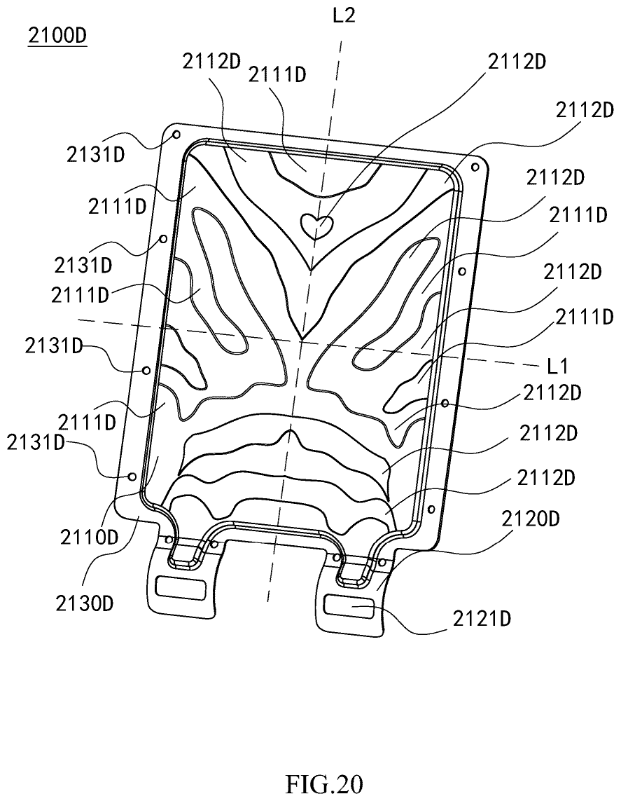

FIG. 20 is a front side view of a front backrest reinforcing mechanism 2100D according to another embodiment of the disclosure. In this embodiment, a plurality of sub-buffer portions 2111D on the reinforcing sheet body are communicated to each other, so as to form one or more buffer portions. Moreover, one or more buffer portions are designed to be symmetrical and divergent in general, such that the stress can be better dispersed. The regions occupied by the plurality of buffer portions 2111D are distributed on the surface of the body 110D of the front backrest reinforcing mechanism 2100D substantially symmetrically, and the recessed depth is no more than 5 mm.

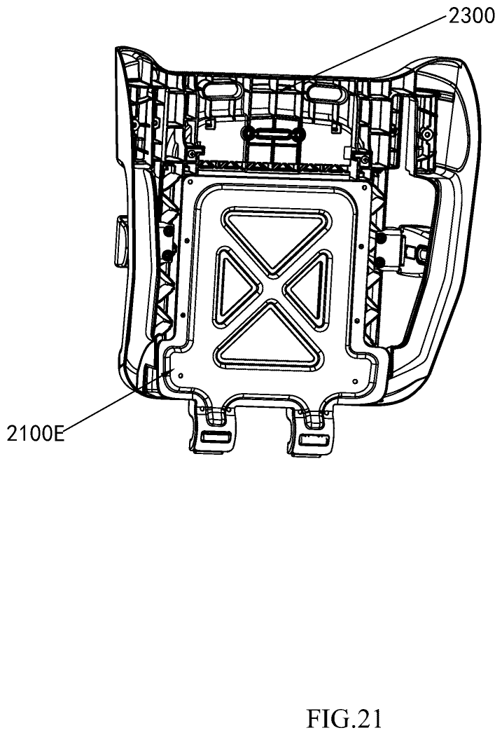

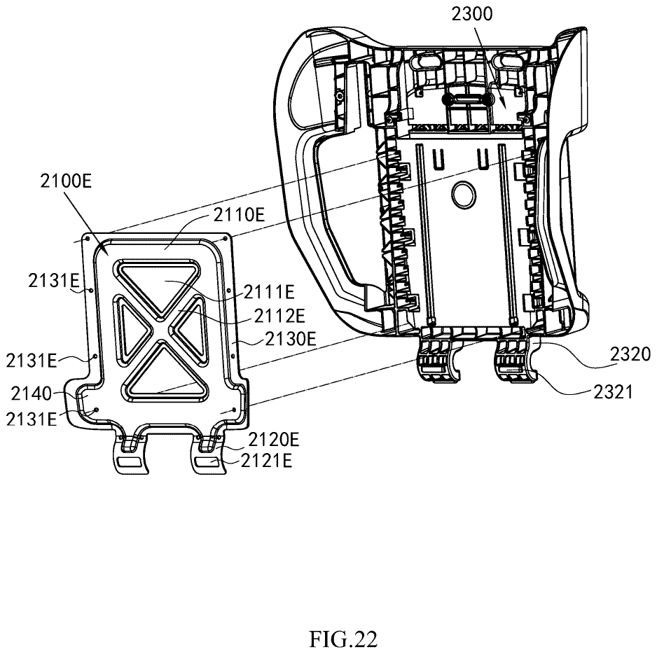

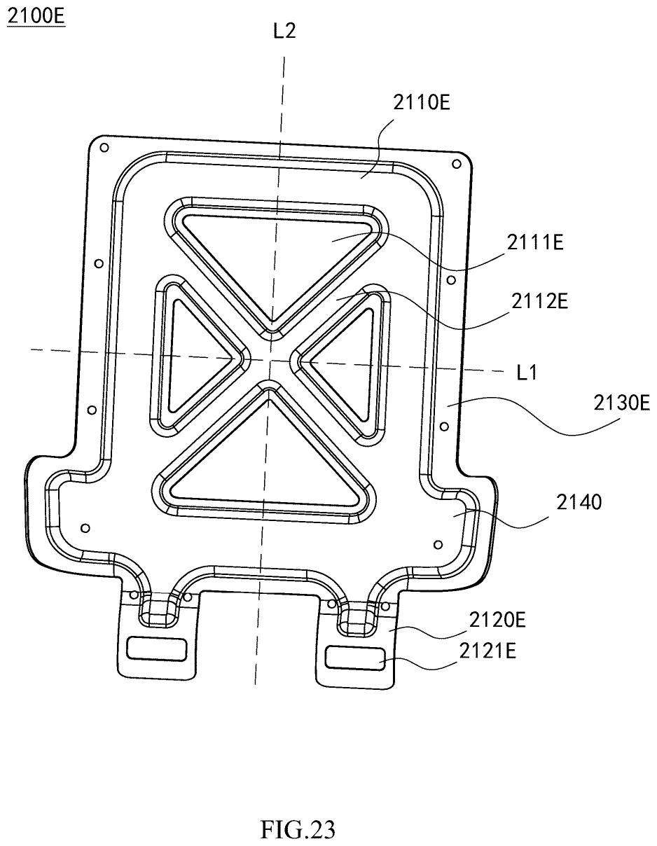

FIGS. 21 to 23 show views of a backrest part of a child safety seat 1 according to another embodiment of the disclosure, wherein FIG. 21 is a front perspective view of the backrest portion 2300 of the child safety seat 1 of the disclosure, and a front side of the backrest portion 2300 is provided with a front backrest reinforcing mechanism 2100E; FIG. 22 is an exploded perspective view of the backrest portion 2300 and the front backrest reinforcing mechanism 2100E of the child safety seat 1 according to the disclosure shown in FIG. 21; and FIG. 23 is a front view of the front backrest reinforcing mechanism 2100E according to the disclosure.

In this embodiment, the front of the backrest portion 2300 is fixedly provided with a front backrest reinforcing mechanism 2100E for ensuring the strength of the backrest portion 2300. The front backrest reinforcing mechanism 2100E is detachably arranged on the backrest portion 2300. Further, fasteners, such as screws, are used to pass through the perforations 2131E in the front backrest reinforcing mechanism 2100E, so as to be connected to and fixed with the fixing holes 2330 in the backrest portion 2300, such that the front backrest reinforcing mechanism 2100E is fixed on the backrest portion 2300. In this embodiment, the front backrest reinforcing mechanism 2100E is closely attached to the backrest portion 2300, which can better enhance the strength of the backrest portion 2300. For example, the shape of the reinforcing sheet may be matched with that of the backrest portion 2300, and the reinforcing sheet is provided with perforations 2131E for fasteners to pass through and be fixed to the fixing holes 2330 in the backrest portion 2300.

As shown in FIG. 23, the front backrest reinforcing mechanism 2100E is, for example, a reinforcing sheet in a left-right symmetrical configuration, such as a reinforcing iron sheet. However, the reinforcing sheet may be made of other metals, such as stainless steel, aluminum alloy and the like.

In this embodiment, the reinforcing sheet is made of a stamped metal plate, and has a body 2110E and an edge portion 2130E around the body 2110E. At least one buffer portion 2111E is formed inside the body 2110E. In this embodiment, the buffer portion 2111E may be a passing through portion which passes through the body 2110E, and the region occupied by the buffer portion 2111E is substantially symmetrically distributed. For example, the body 2110E is provided with four passing through portions passing through the body 2110E, and perforations 2131E are arranged in the edge portion 2130E.

The reinforcing sheet is also provided with clamping portions 2120E connected to the body 2110E. The clamping portions 2120E are located below the body 2110E, and extend by attaching to the connecting hooks 2320 at the lower end of the backrest portion 2300 and arch towards the front side of the seat. The clamping portions 2120E and the backrest portion 2300 may be joined, for example, by welding and clamping. As mentioned above, the surfaces of the connecting hooks 2320 facing the clamping portions 2120E are provided with limiting bulged ribs 2321, and the limiting bulged ribs 2321 pass through the open holes 2121E correspondingly arranged on the clamping portions 2120E, so as to position the clamping portions 2120E on the connecting hooks 2320.

Different from the embodiments shown in FIGS. 11 to 20, the reinforcing sheet is additionally provided with wing panels 2140 on two sides of the lower end of the front backrest reinforcing mechanism 2100E. The wing panels 2140 are integrally formed with the edge portion 2130E, for example, and can be assembled to the backrest portion 2300 in a shape matching manner. For example, fasteners can be used to pass through the perforations 2131E arranged in the wing panels 2140, so as to fixedly connect the reinforcing sheet to the backrest portion 2300. By arranging wing panel 2140 on two sides at a lower end of the reinforcing sheet respectively, the stability of the front backrest reinforcing mechanism 2100E can be enhanced and the attachment to the backrest portion 2300 can be improved, thereby significantly enhancing the strength of the backrest portion 2300.

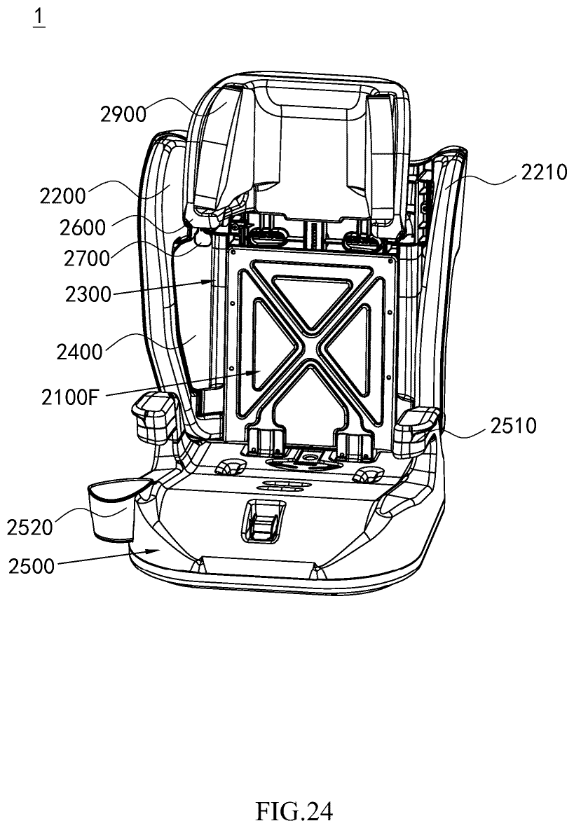

FIG. 24 is a front perspective view of the child safety seat 1 according to an embodiment of the disclosure, in which the front side of the backrest portion 2300 is provided with a front backrest reinforcing mechanism 2100F different from that shown in FIG. 11. The front backrest reinforcing mechanism 2100F has different buffer portions on the body, and is not provided with the pre-positioning hole 2113 shown in FIG. 11. Different from FIG. 11, the clamping portions 2120F of the front backrest reinforcing mechanism 2100F are separately connected to the body.

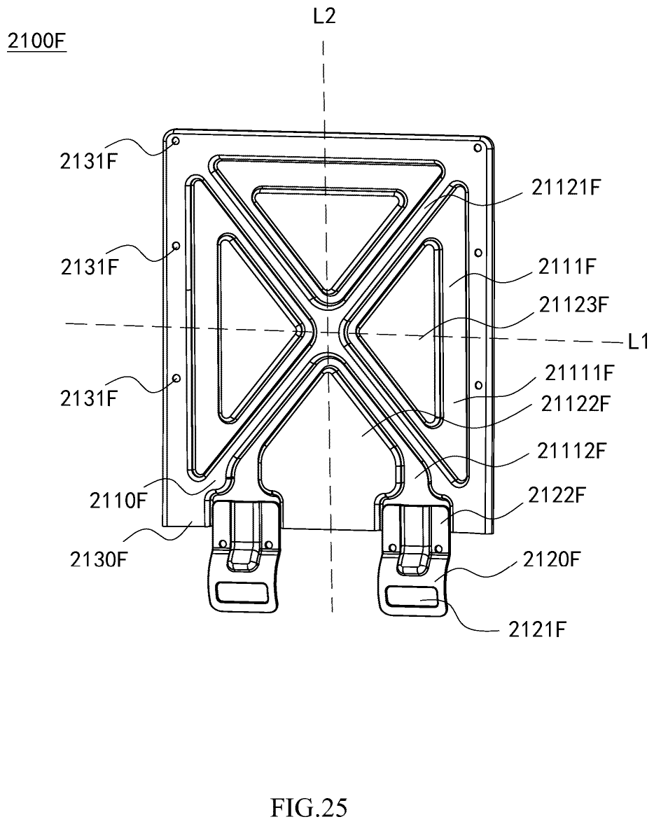

FIG. 25 is a front side view of the front backrest reinforcing mechanism 2100F adopted in FIG. 24. The difference of the reinforcing sheet between this embodiment and the previous embodiments is that the reinforcing sheet is divided into clamping portions 2120F and a body 2130F separately, and then the clamping portions 2120F and the body 2130F are connected together by welding, and a wall thickness of each of the clamping portions 2120F is greater than that of the body 2110F.

The disclosure is explained in detail by taking FIG. 25 as an example, and reinforcing sheets with other shapes and structures can also be used in the same way. In an embodiment, the wall thickness of the body 2110F (including its edge portion 2130F) ranges between 1.2 mm-1.5 mm, and the wall thickness of the clamping portions 2120F ranges between 1.6 mm-2 mm. In another embodiment, the wall thickness of the body 2110F (including its edge portion 2130F) ranges between 1.2 mm-1.8 mm, and the wall thickness of the clamping portions 2120F ranges between 1.2 mm-1.8 mm. For example, the wall thickness of the body 2110F (including its edge portion) may be 1.2 mm, and the wall thickness of the clamping portions 2120F may be 2 mm. When it is impacted, the clamping portions 2120F bear a larger stress, so the clamping portions 2120F according to the disclosure is designed to be thicker than the body 2110F, such that it has a higher strength. In this embodiment, after the body 2110F and the clamping portions 2120F are processed separately, the two separated structures are connected together by welding, and the material for both is SPFH590, for example. The materials of the body 2110F and the clamping portions 2120F may also be different, i.e., materials with different strengths can be selected. In such case, the thickness of the clamping portions 2120F may not be greater than that of the body 2110F of the reinforcing structure.

In this embodiment, the body 2110F may be substantially equally divided into four (upper, lower, left, right) regions by the horizontal reference line L1 and the vertical reference line L2, and one or more buffer portions 2111F may be arranged in each region. The buffer portion 2111F may be a plurality of grooves recessed from the front side of the body 2110F, and any two grooves can be or can be not communicated to each other. A plurality of buffer portions 2111F may include first buffer portion 21111F and second buffer portion 21112F. An “X” shaped first bulge 21121F is formed between the buffer portions 2111F.

The second buffer portion 21112F located relatively below the first buffer portion 21111F is irregular shaped, which extends to the lower edge of the reinforcing sheet to accommodate the separately welded clamping portions 2120F. Specifically, the first buffer portion 21111F forms a triangle, and each first buffer portion 21111F is arranged around a third bulge 21123F with a smaller size, moreover, a lower second buffer portion 21112F is arranged around a second bulge 21122F. The shape of the second bulge 21122F is similar to an arrow shape, and the second bulge 21122F extends downwardly to the lower edge of the reinforcing sheet 2100F, and forms a welding portion together with the irregular edge of the second buffer portion 21112F for closely welding to welding portions of the clamping portions 2120F. It should be noted, in this embodiment, the first to third bulges 21121F, 21122F, 21123F can also provide a buffering effect when being impact, thereby reducing the horizontal displacement of the head.

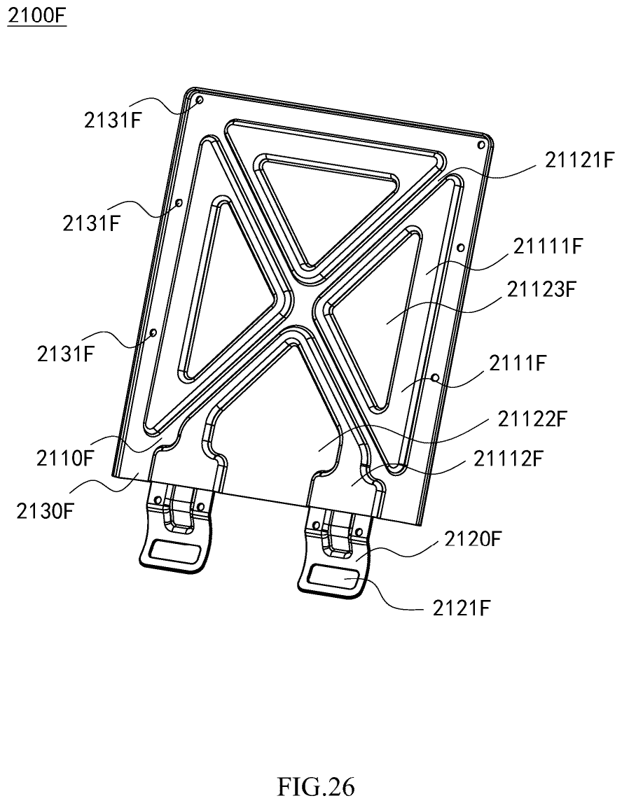

FIG. 26 is a rear side view of the front backrest reinforcing mechanism 2100F adopted in FIG. 24. In this embodiment, the clamping portions 2120F are only welded to the front side of the reinforcing sheet 2100F, such that the clamping portions 2120F can better mechanically attach the body 2110F and the edge portion 2130F to the backrest portion 2300, but the disclosure is not limited thereto.

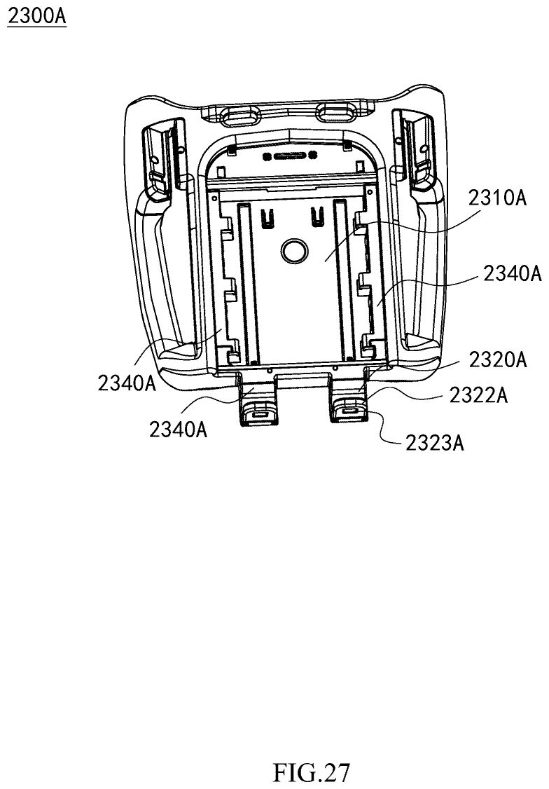

FIG. 27 is a rear perspective view of a backrest portion 2300A of a child safety seat according to an embodiment of the disclosure, in which a back side of the backrest portion 2300A is provided with cover plates 2340A. Different from FIG. 13, the connecting hooks 2320A each has a connecting hook extension 2322A, and the connecting hook extension 2322A has a locking hole 2323A in the form of a through hole in the middle for locking the backrest body 2310A.

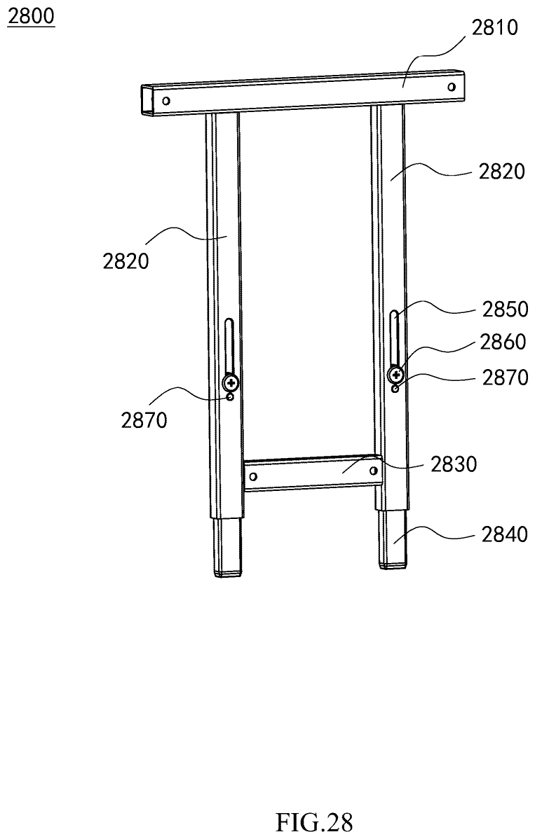

FIGS. 28 to 31A-31B show a rear backrest reinforcing mechanism 2800 according to an embodiment of the disclosure. In this embodiment, the backrest reinforcing mechanism is implemented as a rear backrest reinforcing mechanism 2800, which is installed on a rear side of the backrest portion 2300, 2300A in a form of a detachable reinforcing bracket. The reinforcing bracket is fixed to the rear side of the backrest portion 2300, 2300A by fasteners, and the lower end of the reinforcing bracket, such as the locking rod 2840, is installed at a position where the backrest portion 2300, 2300A is connected to the seat portion 2500 of the child safety seat 1, 1A, in which the lower end of the reinforcing bracket is retractable with respect to the upper end thereof.

The rear backrest reinforcing mechanism 2800 includes at least one first rod and at least one second rod fixedly connected to the first rod, and the first rod and/or second rod is fixed to a rear side of the backrest portion 2300, 2300A by fasteners, and has different extension directions respectively, wherein at least one locking rod is sleeved on the corresponding second rod from the outside or from the inside, and can slide up and down with respect to the sleeved second rod, and an end of at least one locking rod 2840 extends and protrudes from the sleeved at least one second rod 2820, so as to be detachably installed at the corresponding position of the backrest portion 2300, 2300A.

FIG. 28 is a perspective view of a rear backrest reinforcing mechanism 2800 according to an embodiment of the disclosure. In the embodiment shown in FIG. 28, the rear backrest reinforcing mechanism 2800 is designed as a left-right symmetrical reinforcing bracket. The rear backrest reinforcing mechanism 2800 includes an upper first rod 2810 and a lower first rod 2830 which are arranged apart from each other, and two second rods 2820 which are arranged apart from each other, i.e., a left second rod and a right second rod. The left second rod and the right second rod are fixedly connected to the upper first rod 2810 and the lower first rod 2830, thus forming an approximately rectangular frame. In this embodiment, the two second rods 2820 are fixed to the upper first rod 2810 on top end side, and the length of the upper first rod 2810 may be greater than or equal to the spacing between the two second rods 2820, while the lower first rod 2830 is fixed between the two second rods 2820. By arranging the upper first rod 2810 and the lower first rod 2830, stress can be distributed in the rear backrest reinforcing mechanism 2800 more uniformly from top to bottom.

The upper first rod 2810, the lower first rod 2830 and/or the second rods 2820 are fixed to the rear sides of the backrest portion 2300, 2300A by fasteners. In this embodiment, the locking rods 2840 are sleeved inside the second rods 2820, can slide up and down with respect to the sleeved second rods 2820, and partially extend from the lower end of the sleeved second rods 2820, so as to be installed at the corresponding positions at the lower portions of the backrest portion 2300, 2300A. In this embodiment, a left locking rod and a right locking rod are arranged corresponding to the left second rod and the right second rod, and the left locking rod and the right locking rod are respectively sleeved on and extend out of the lower ends of the left second rod and the right second rod.

A chute 2850 is disposed on the second rod 2820, and an operating assembly can be inserted into the chute 2850 from outside, so as to guide one of the locking rods 2840 to slide upwardly and downwardly along the chute 2850. In this example, the operating assembly may include two sliding members 2860, such as screws. The sliding members 2860 are located at the lower ends of the chutes 2850, so that the part of the locking rods 2840 extending out of the second rods 2820 has a maximum length.

Optionally, a resetting spring 2880 is provided according to the disclosure. Specifically, the second rod 2820 is provided with a limit hole h1 located below the chute 2850, and a pin 2870 is inserted into the limit hole h1 to position an upper end of the resetting spring 2880. The resetting spring 2880 is adapted to alway exerts an outward force to the locking rod 2840. The resetting spring 2880 and the pin 2870 are used to continually keep the locking rod 2840 downward and position it inside the locking hole 2323A to prevent the locking rod 2840 from separating away, but they are not necessary elements.

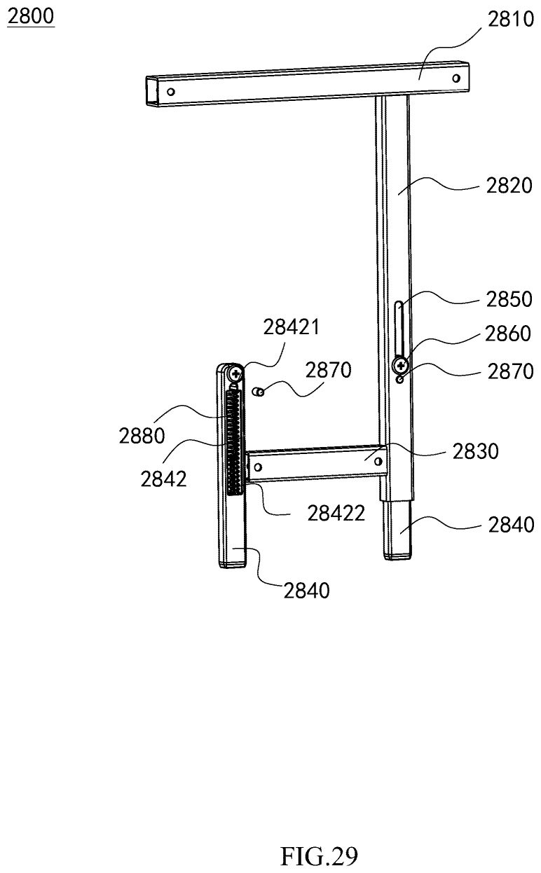

FIG. 29 is a perspective view of the rear backrest reinforcing mechanism 2800 shown in FIG. 28, in which one of the second rods 2820 is removed to facilitate showing the internal structure. The locking rod 2840 is provided with a spring receiving portion 2842 and a sliding member 2860 located above the spring receiving portion 2842. A lower end of the resetting spring 2880 is fixed on the spring receiving portion 2842. In this example, a lower end of the spring receiving portion 2842 is provided with a limit post 28422, and the resetting spring 2880 is sleeved on the limit post 28422, moreover, an upper end of the spring receiving portion 2842 is provided with an avoidance notch 28421 for avoiding the pin 2870.

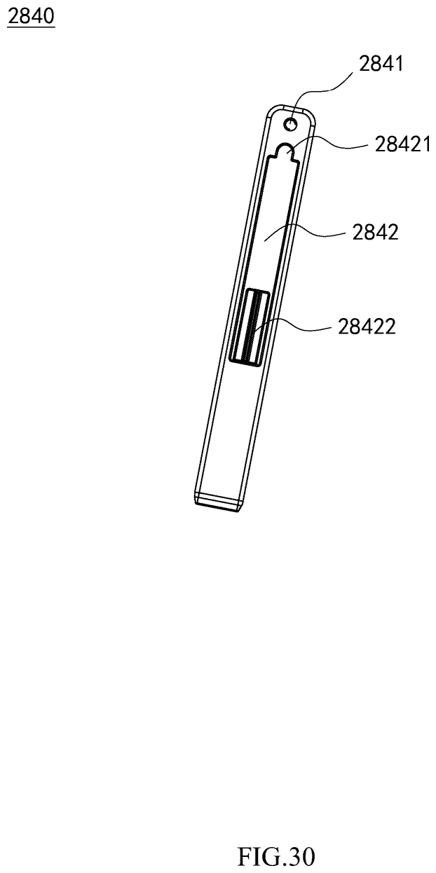

FIG. 30 is a front view of the locking rod of the rear backrest reinforcing mechanism 2800 according to the disclosure. After removing the resetting spring 2880, it can be clearly seen that the lower end of the spring receiving portion 2842 is provided with a limit post 28422, and the upper end of the spring receiving portion 2842 is provided with an avoidance notch 28421 for avoiding the pin 2870. In addition, a connection hole 2841, such as a screw connection hole, for receiving a sliding member 2860 is arranged above the spring receiving portion 2842.

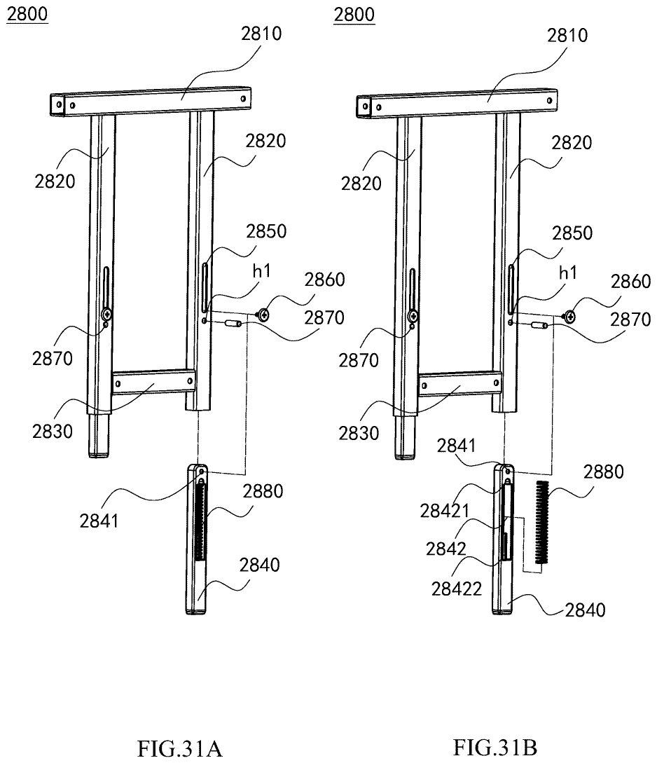

FIGS. 31A and 31B respectively show portionially exploded perspective views of the rear backrest reinforcing mechanism 2800 according the disclosure in different forms. As can be understood from FIG. 31A, the sliding members 2860 can be inserted into the connection holes 2841 of the locking rods 2840 by passing through the outer sides of the chutes 2850, so as to bring the locking rods 2840 to slide in the second rods 2820. The resetting spring 2880 is placed into the spring receiving portions 2842 and fixed at the lower ends. The resetting spring 2880 is taken out from the spring receiving portion 2842 in FIG. 31B, and its upper ends are not fixed in the spring receiving portions 2842, but limited by the pins 2870 inserted into the limit holes h1.

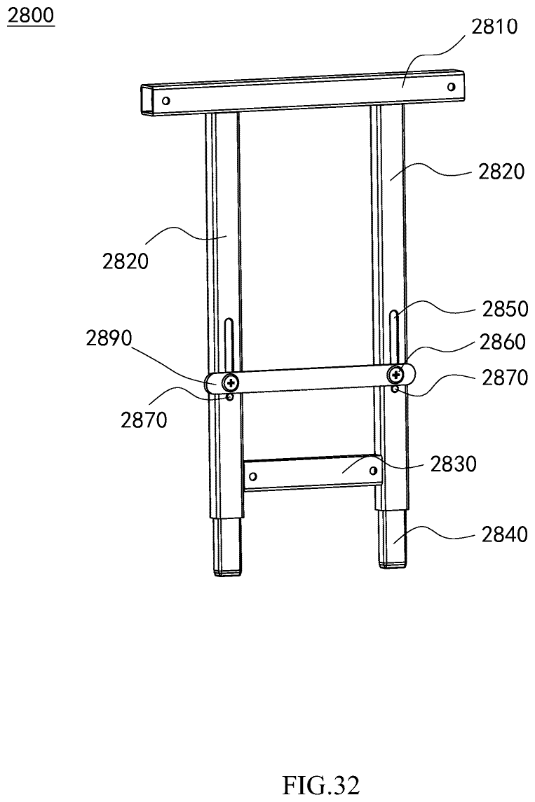

FIG. 32 is a perspective view of a rear backrest reinforcing mechanism according to another embodiment of the disclosure. Different from the embodiment shown in FIG. 28, the operating assembly may further include a linkage rod 2890. The linkage rod 2890 may have two clamping portions, and the sliding members 2860 are arranged on the linkage rod 2890 through the two clamping portions respectively. In detail, the sliding members 2860 pass through the linkage rod 2890 and are inserted into the chutes 2850. By holding the linkage rod 2890 to slide upwardly, the locking rods 2840 on both sides can be directly lifted together, such that the two locking rods 2840 can be expanded and retracted synchronously, thereby facilitating the locking operation and unlocking operation of the backrest portion. In this embodiment, the first rod 2830 may also be omitted.

In another embodiment, the operating assembly may only include the linkage rod 2890, and the linkage rod 2890 has two clamping members. Each clamping member can be inserted into the connection hole 2841 of a corresponding locking rod 2840 and the chute 2850 of a corresponding second rod 2820. By holding the linkage rod 2890 to slide upwardly can synchronously bring the locking rods 2840 on both sides to lift, which is simple in structure and convenient in operation.

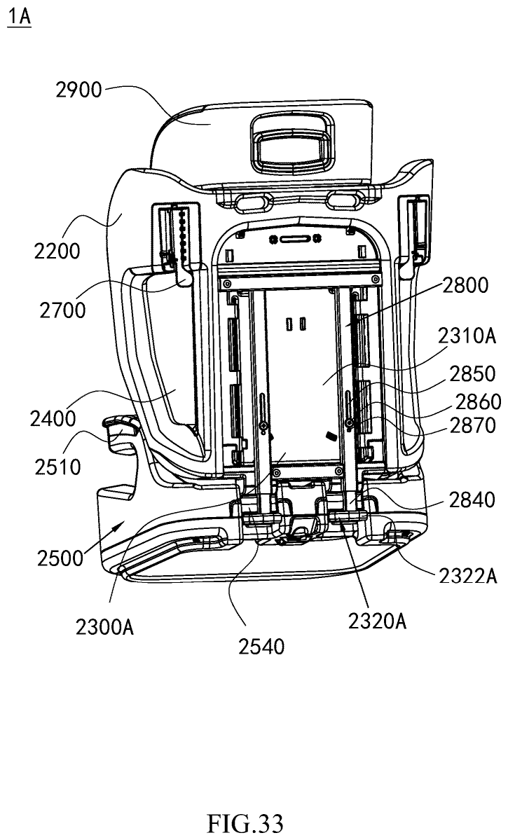

FIG. 33 is a rear perspective view of the child safety seat 1A according to an embodiment of the disclosure, in which a back side of the backrest portion 2300A is provided with a rear backrest reinforcing mechanism 2800.

The backrest body 2310A of the backrest portion 2300A is located above the clamping rods 2540, and the connecting hooks 2320A of the backrest portion 2300A extend firstly downward from the lower side of the backrest body 2310A, and then preferably bend towards the front of the seat portion, such that when the backrest portion 2300A is installed on the seat portion 2500, the connecting hooks 2320A can penetrate into the clamping ports 2550, and bypass the clamping rod 2540, and the connecting hook extensions 2322A located at free ends of the connecting hooks 2320A can generally horizontally extend backward from the backrest portion 2300A, moreover, a locking hole 2323A (not shown) is arranged in the middle of the connecting hook extension 2322A for the locking rod 2840 of the rear backrest reinforcing mechanism 2800 to penetrate and to be locked, wherein the sliding members 2860 are at the lower ends of the chutes 2850 in the locked state.

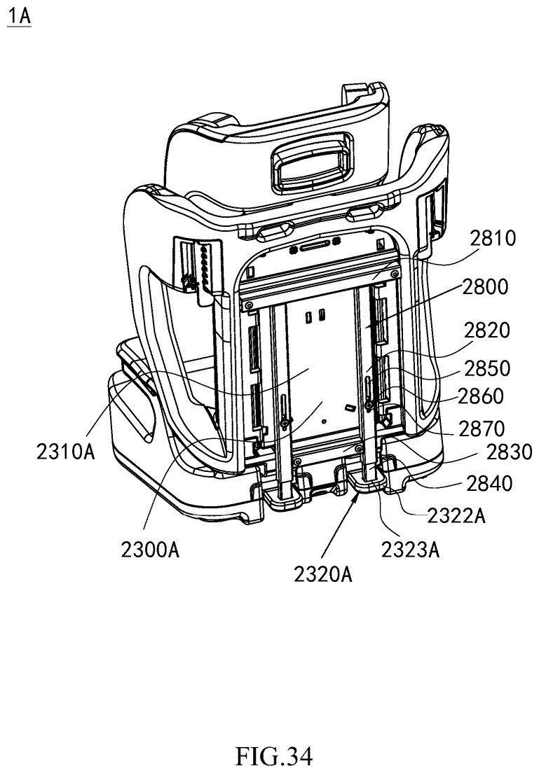

FIG. 34 is a rear perspective view of the child safety seat 1A shown in FIG. 33 from another angle. As can be better seen from FIG. 34, the locking rods 2840 of the backrest reinforcing mechanism 2800 penetrate into the locking holes 2323A, such that the backrest reinforcing mechanism 2800 and the backrest portion 2300A fixedly connected to it are in the locked state.

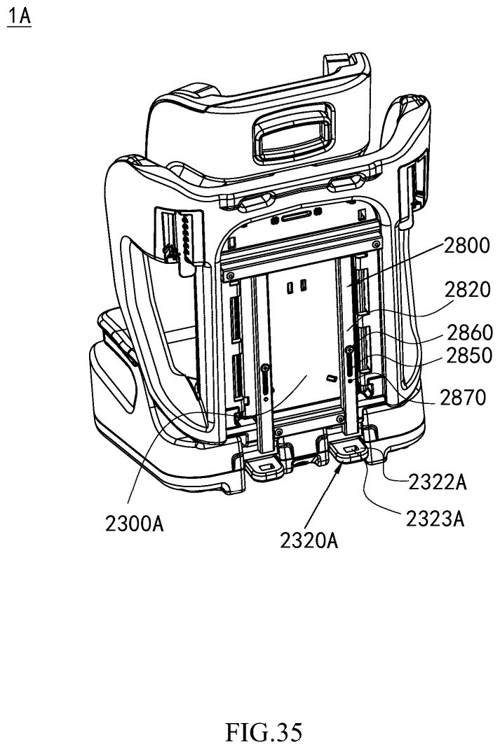

FIG. 35 shows that the rear backrest reinforcing mechanism 2800 of the child safety seat 1A shown in FIG. 34 is in an unlocked state during installation or disassembly. In the unlocked state, the sliding members 2860 slide to a top end in the chutes 2850, and bring the locking rods 2840 to separate from the locking holes 2323A and retract into the second rods 2820. In such case, since upper sides of the resetting springs 2880 are limited by the pins 2870 in the limit holes h1, the resetting springs 2880 are compressed and preloaded as the lower ends of the spring receiving portions 2842 of the locking rods 2840 move upwardly. When the external force acting on the sliding members 2860 disappears, the spring force of the resetting springs 2880 causes the locking rods 2840 to automatically return to the above-mentioned locked state, that is, the locking rods 2840 are inserted into the locking holes 2323A.

According to the disclosure, it is advantageous that the position of the bracket-type locking rod can be limited within the locking hole with a relative strong strength, and will not break in connection of the bracket and the seat portion or cause the locking rod to be separated from the locking hole during the impact.

To sum up, since the stress point of the child safety seat is on the backrest portion during impact, and fixing of the car-mounted safety belt on the seat portion body is asymmetric, if the strength of the backrest portion is not enough, the seat portion body will generate a torsion force to deform the backrest portion when the car is impacted. Especially in the Harness mode, the restraint on a child will also be weakened, which will lead to the child leaning forward greatly and the horizontal displacement of the head will be larger. By adding a reinforcing structure on the backrest portion to improve the strength of the backrest portion, the horizontal displacement of the head can be well improved. If the backrest reinforcing mechanism is a reinforcing sheet, its structure is simple, easy to realize and convenient for production and processing. If the backrest reinforcing mechanism is a reinforcing bracket, it has better reinforcement effect and can better improve the horizontal displacement of the head.

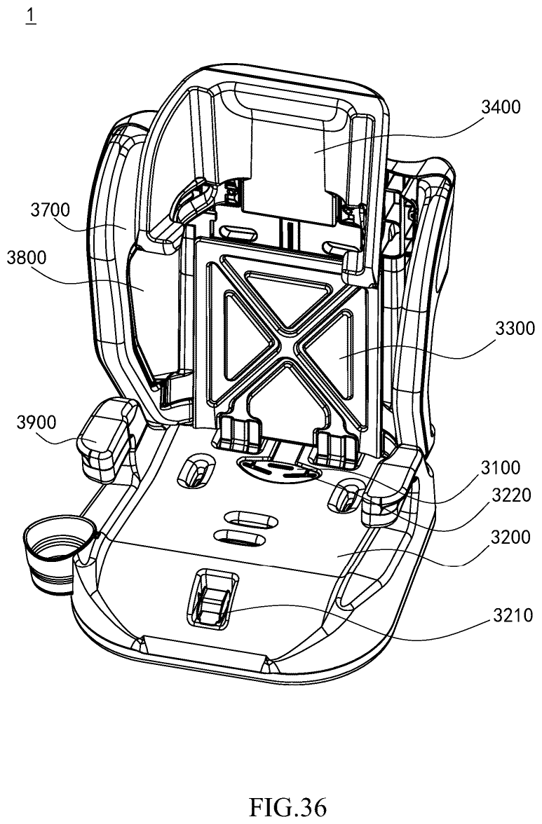

In a third aspect of the disclosure, FIG. 36 shows the child safety seat 1 according to the disclosure.

Regarding the binding path of the car-mounted safety belt (not shown), the child safety seat 1 according to the disclosure has two use modes, i.e., a Harness mode and a Booster mode.

In the Harness mode, the shoulder harness of the car-mounted safety belt sequentially passes through a gripper (not shown) arranged at a connection of the backrest portion 3300 of the child safety seat 1 and the side wing portion 3700, and an upper portion of the opening 3800 for the car-mounted safety belt to pass through near the backrest portion 3300 and a side close to a door, while the waistbelt of the car-mounted safety belt passes through a lower portion of an opening 3800 on the side close to the door, and then passes through a lower portion of the opening 3800 near the backrest portion 3300 and on a side away from the door together with the shoulder harness, so as to be inserted into and fixed with a safety belt buckle on a car seat.

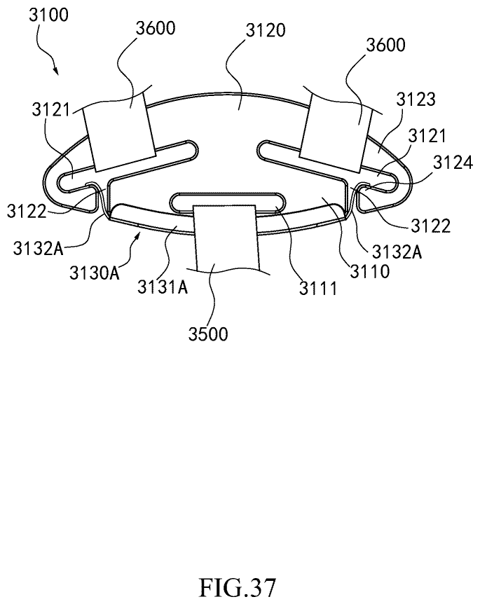

In the Harness mode, the car-mounted safety belt is used to fix the child safety seat 1 on the car seat portion. When sitting, the child is fixed in the child safety seat 1 by using the shoulder harness 3600 (see FIG. 37) specially configured for the child safety seat 1, and the shoulder harness 3600 is connected to an adjusting strap 3500 (see FIG. 37) by using the connector body 3100, and the adjusting strap 3500 is used to adjust the shoulder harness 3600 according to the specific situation of the child, wherein the shoulder harness 3600 is guided from the front side to the rear side of the child safety seat 1 through a corresponding shoulder harness opening, and is connected to the adjusting strap 3500 on the rear side of the backrest portion 3300 through the connector body 3100. The adjusting strap 3500 is then brought from the rear sides of the backrest portion 3300 and the seat part 3200 to the front side of the child safety seat 1, and can be locked and unlocked by, for example, an A-LOCK 3210 arranged at the front of the seat part 3200.

In the Booster mode, the shoulder harness of the car-mounted safety belt sequentially passes through the guide between the backrest portion 3300 and the headrest portion 3400, and passes under the seat armrest 3900 on the side away from the door, while the waistbelt of the car-mounted safety belt passes under the armrest 3900 on the side close to the door, and then passes under the armrest 3900 on the side away from the door together with the shoulder harness, so as to be inserted into and fixed with the safety belt buckle on the car seat.

In the Booster mode, the child is fixed in the child safety seat 1 by using the car-mounted safety belt. In such case, the fixed connection between the shoulder harness 360, the connector body 3100 and the adjusting strap 35000 specially configured for the child safety seat 1 in the Harness mode can be detached, and the connector body 3100 for connecting the shoulder harness 3600 and the adjusting strap 3500, such as a T-shaped connecting sheet or a T-shaped iron sheet, can be accommodated in an accommodating recess 3220 on the seat part 3200 shown in FIG. 36. For example, after the shoulder harness 3600 is detached, the connecting assembly or only the connector body 3100 can be accommodated in an accommodation space or an accommodating recess 3220 arranged on an upper rear side of the seat part 3200. The accommodating recess 3220 is preferably arranged on a rear side region of the seat part 3200, that is, the region on the rear side of the seat part 3200 and close to the backrest portion 3300, such that the connecting assembly or only the connector body 3100 can be safely and covertly accommodated in a specific position when the connecting assembly is not needed, so as to be taken out for use again. In addition, it can also be considered that the accommodating recess 3220 may also be arranged at other positions, such as the back of the backrest portion 3300, and the accommodating recess 3220 can also be provided with a clamping device, for example, to fix the connector body 3100.

FIG. 37 is a side view of a connecting assembly according to the first embodiment of the disclosure first. The connecting assembly according to the disclosure includes: a connector body 3100, connected to a shoulder harness 3600 of the child safety seat 1 and connected to an adjusting strap 3500; and a stopper 3130A, connected to the connector body 3100 and being able covering a detachment opening 3122 of the shoulder harness 3600 to prevent the shoulder harness 3600 from separating away.

According to this embodiment, the connector body 3100 includes a main body portion 3110 for connecting to the adjusting strap 3500. The main body portion 3110 is provided with an adjusting strap connection hole 3111. The adjusting strap connection hole 3111 is, for example, arranged in a middle position of the main body portion 3110, and is used for connecting to the adjusting strap 3500 and is designed, for example, as a transverse slot adapted to the shape of the adjusting strap 3500. The adjusting strap 3500 can, for example, pass through the adjusting strap connection hole 3111 and be connected to the A-LOCK 3210 shown in FIG. 36, so as to adjust, lock and unlock the adjusting strap 3500.

The connector body 3100 further includes an extension portion 3120 connected to the main body portion 3110. The extension portion 3120 and an upper side of the main body portion 3110 in the height direction define shoulder harness connection holes 3121, and the extension portion 3120 and left and right end sides of the main body portion 3110 define shoulder harness detachment openings 3122. The shoulder harness connection holes 3121 are used to connect to the shoulder harness 3600, and the shoulder harness detachment openings 3122 are communicated with the shoulder harness connection holes 3121 for detaching the shoulder harness 3600 from the connector body 3100 through the shoulder harness detachment openings 3122, for example, when Booster mode is used, so as to save, i.g., the connector body 3100. According to this embodiment, the extension portion 3120 extends transversely on both sides at an upper end of the main body portion 3110 with respect to the main body portion 3110 and forms a shape similar to “T” with the main body portion 3110. The extension portion 3120 and the main body portion 3110 define the shoulder harness connection holes 3121 and the shoulder harness detachment openings 3122 at the ends 3123 by using protruding portions 3124. The protruding portions 3124 are formed by extending from lower ends of the ends 3123 to the main body portion 3110. According to the disclosure, the outer shape of the connector body 3100 may be configured to be generally similar to an ellipse to provide a compact and high-strength construction solution.

According to this embodiment, the stopper 3130A has a stopper body 3131A. The stopper body 3131A is substantially in a long strip shape, and its shape is adapted to the shape of the lower side of the main body portion 3110, and detachably connected, e.g., clamped, to the main body portion 3110 of the connector body 3100. The stopper 3130A also has separation preventing portions 3132A. According to this embodiment, the stopper body 3131A extends towards both sides in the longitudinal direction to form the separation preventing portions 3132A. The separation preventing portions 3132A may cooperate with the ends 3123 of the extension portion 3120, so as to prevent the shoulder harness 3600 from separating away. According to this embodiment, the separation preventing portion 3132A is configured as a hook, for example, an elastic sheet with elasticity, and the hooks are arranged on both end sides of the stopper body 3131A and detachably connected to the protruding portions 3124 on the ends 3123 of the extension portion 3120 of the connector body 3100. The hooks may be integrally formed with the stopper body 3131A, or may be separately formed.

For example, in the Harness mode, the hooks are elastically clamped to the upper sides of the protruding portions 3124, i.e., into the shoulder harness connection holes 3121 as shown in the figure, thereby closing the shoulder harness detachment openings 3122 and thus preventing the shoulder harness 3600 from coming out of the shoulder harness connection holes 3121. When changing to Booster mode, for example, the user can deform the hooks and disconnect them from the protruding portions 3124, e.g., by using tool, and if necessary, the stopper 3130A can be separated from the main body portion 3110 of the connector body 3100, such that the shoulder harness 3600 can be separated from the shoulder harness connection holes 3121 through the shoulder harness detachment openings 3122. After the shoulder harness 3600 is detached, the connector body 3100 can be accommodated in the accommodating recess 3220 of the seat part 3200 as shown in FIG. 36, or be accommodated in any possible position. If it is necessary to change from the Booster mode back to the Harness mode, the user can firstly detach the stopper 3130A from the main body portion 3110, and then fixedly connect the stopper 3130A to the main body portion 3110 after installing the shoulder harness 3600 into the shoulder harness connection holes 3121 through the shoulder harness detachment openings 3122. In such case, the hooks are clamped to the upper sides of the protruding portions 3124 in a shape matching manner again and provide a fixing force.

With the disclosure, when the Harness usage mode is converted to the Booster use mode, the shoulder harness fixing point of the Harness can be detached, and can be restored after detachment, that is, it will not be destructively detached, thus saving the cost.

According to another embodiment of the disclosure, when a detachment opening is arranged for the adjusting strap 3500, the stopper 3130A can also be arranged to cover the detachment opening of the adjusting strap 3500, so as to prevent the adjusting strap 3500 separating from the adjusting strap connection hole 3111, but the disclosure is not limited thereto.

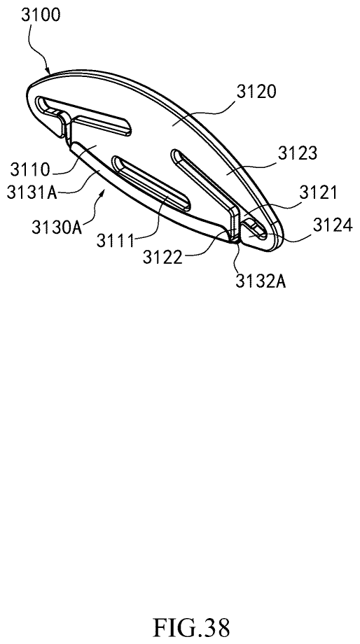

FIG. 38 is a perspective view of a connecting assembly according to the first embodiment of the disclosure, in which the connector body 3100 and the stopper 3130 are in an assembled state. As shown in FIG. 38, the separation preventing portions 3132A or the hooks of the stopper 3130A are clamped, e.g., overlapped in a shape matching manner, on the protruding portions 3124 of the extension portion 3120 of the connector body 3100, thereby closing the shoulder harness detachment openings 3122 and preventing the shoulder harness 3600 in the shoulder harness connection holes 3121 from separating away. In this embodiment, the stopper body 3131A of the stopper 3130A is configured as groove, and the lower side of the main body portion 3110 of the connector body 3100 is inserted into the groove, and the stopper 3130 is fixed to the main body portion 3110 by, for example, elastic clamping of the hooks on the protruding portions 3124. In addition, the connector body 3100 can be connected to the main body portion 3110 in other ways, but the disclosure is not limited thereto.

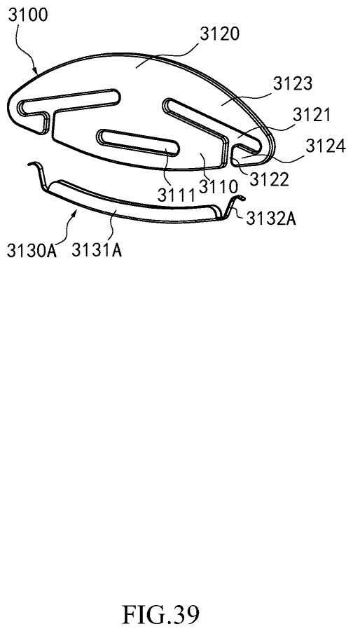

FIG. 39 is an exploded perspective view of the connecting assembly according to the first embodiment of the disclosure first, in which the connector body 3100 and the stopper 3130 are in an unassembled state. As shown in FIG. 39, the stopper 3130A can be made of a sheet, for example, an iron sheet, and two ends of the sheet form hook-shaped separation preventing portions 3132A for closing the shoulder harness detachment openings 3122. The shapes of the separation preventing portions 3132A are adapted to the protruding portions 3124. In order to insert the main body portion 3110, two side portions of the sheet can be bent upward to form a stopper body 3131A adapted to the shape of the lower side of the main body portion 3110. With this embodiment, the stopper 3130A can be implemented with a simple sheet material and processing technology, thus making the cost low and easy to manufacture.

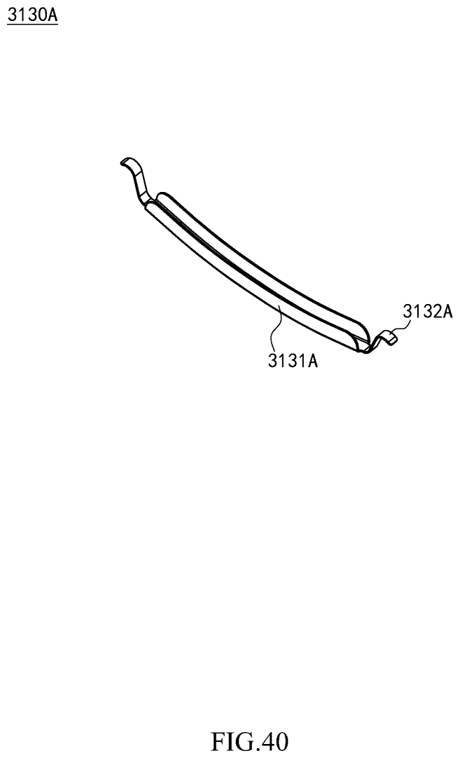

FIG. 40 is a perspective view of the stopper 3130A according to a first embodiment of the disclosure. It can be better seen that according to the disclosure, the stopper body 3131A has a bottom and two side walls, and hook-shaped separation preventing portions 3132A are located at both ends of the stopper 3130A. According to this embodiment, the hook-shaped separation preventing portions 3132A are integrally formed with the stopper body 3131A, but the disclosure is not limited thereto.

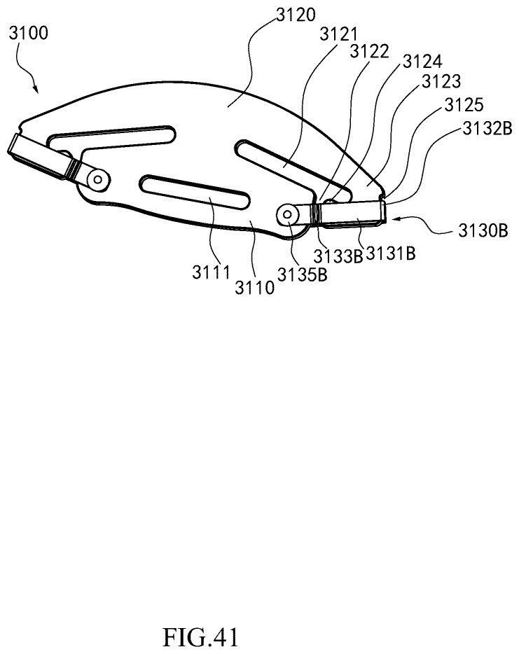

FIG. 41 is a front perspective view of a connecting assembly according to a second embodiment of the disclosure. According to this embodiment, the stopper 3130B includes a stopper body 3131B and separation preventing portion 3132B, and the stopper body 3131B extends towards a free end in the longitudinal direction to form a separation preventing portion 3132B. The stopper body 3131B is pivotably connected to the main body portion 3110 of the connector body 3100, for example, to the left and right end sides of the main body portion 3110, through a pivoting coupler 3135B, such as a pin. The separation preventing portion 3132B is configured as a buckle, which can be integrally formed with the stopper body 3131B, and the separation preventing portion 3132B can be detachably clamped to the end 3123 of the extension portion 3120. According to an embodiment, the separation preventing portion 3132B can be pivoted into clamping recess 3125 arranged on the end 3123. The clamping recess 3125 is, for example, notch, and its shape is adapted to the separation preventing portion 3132B. The clamping recess 3125 may also be formed with flange for the separation preventing portion 3132B, which can prevent the separation preventing portion 3132B from being excessively pivoted and going up over the end 3123 to reach the upper side of the end 3123.

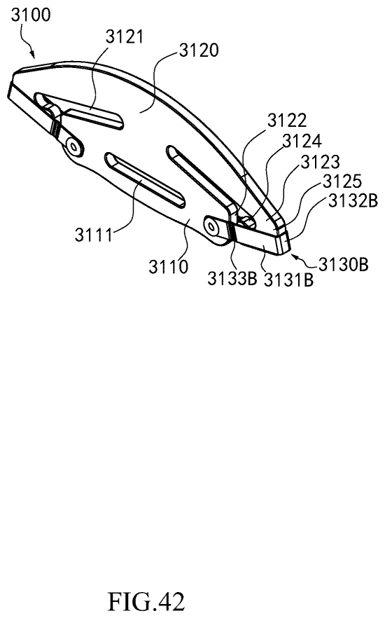

FIG. 42 is a side perspective view of the connecting assembly according to the second embodiment of the disclosure. The stopper 3130B is provided with recessed portion 3133B corresponding to the shoulder harness detachment opening 3122 of the connector body 3100. It can be seen that the recessed portions 3133B are arranged symmetrically on both sides on the stopper body 3131B of the stopper 3130B provided with, for example, a bottom and two side walls, thus can be adapted the shoulder harness detachment openings 3122 in shape.

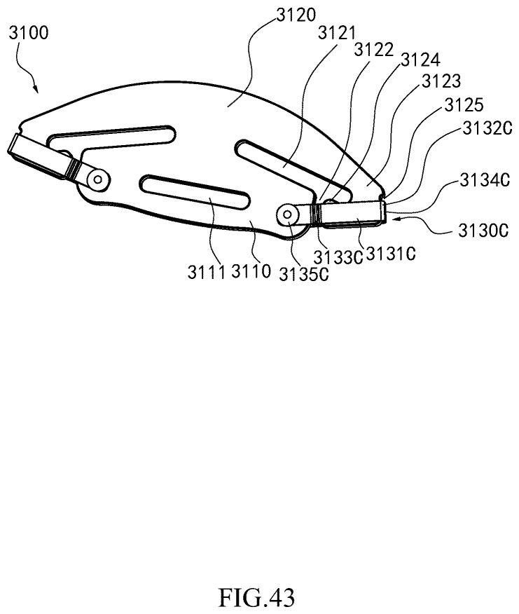

FIG. 43 is a front perspective view of a connecting assembly according to a third embodiment of the disclosure. According to this embodiment, the stopper 3130C includes a stopper body 3131C and a separation preventing portion 3132C, and the stopper body 3131C extends towards a free end in the longitudinal direction to form the separation preventing portion 3132C. The stopper body 3131C is pivotably connected to the main body portion 3110 of the connector body 3100 through a pivoting coupler 3135C, such as a pin, e.g., connected to the main body portion 3110 in the front-rear direction. The separation preventing portion 3132C is configured as a buckle, which can be integrally formed with the stopper body 3131C, and the separation preventing portion 3132C is detachably clamped to the end 3123 of the extension portion 3120. According to an embodiment, the separation preventing portion 3132C can be pivoted into the clamping recess 3125 arranged on the end 3123. The clamping recess 3125 is, for example, notch, and its shape is adapted to the separation preventing portion 3132C. The end 3123 may also be formed with flange for the separation preventing portion 3132C, and the flange arranged on the upper side of the clamping recess 3125. The flange can prevent the separation preventing portion 3132C from being excessively pivoted and going up over the end 123.

Additionally or alternatively, according to the disclosure, recessed portion 3133C may be arranged on the stopper body 3131C, for example, the recessed portions 3133C may be symmetrically arranged on the front and rear sides of the stopper body 3131C, and the recessed portion 3133C may be adapted to the size of the shoulder harness detachment opening 3122, so as to be clamped into the shoulder harness detachment opening 3122, thereby positioning the stopper 3130C in position for preventing the shoulder harness 3600 from separating away more firmly and in a more shape-fitting manner.

The arrangement according to this embodiment may refer to the second embodiment shown in FIGS. 41 to 42.

Different from the second embodiment, this embodiment is additionally provided with a fixing convex 3134C on the top end of the separation preventing portion 3132C. The fixing convex 3134C can cooperate with the corresponding structure in the clamping recess 3125, so as to provide additional fixing force, thus achieving more firm fixing.

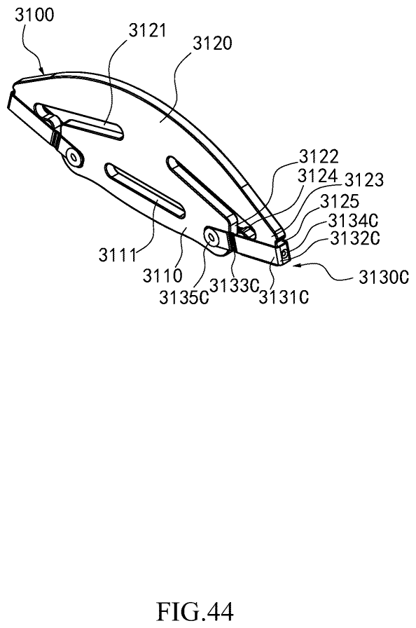

FIG. 44 is a side perspective view of the connecting assembly according to the third embodiment of the disclosure. It can be clearly recognized that the fixing convex 3134C arranged on the top end of the separation preventing portion 3132C can be clamped into the corresponding structure on the clamping recess 3125 of the extension portion 3120. In addition, it can be seen that the recessed portions 3133C are symmetrically arranged on the front and rear sides of the stopper body 3131C of the U-shaped stopper 3130C, thereby being adapted in shape to the shoulder harness detachment opening 3122.

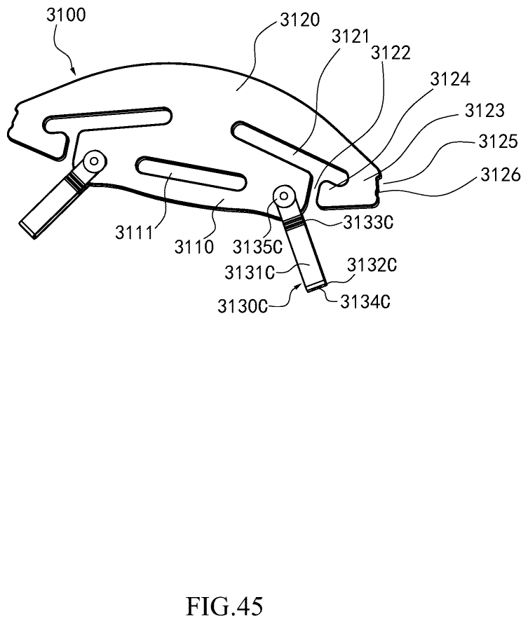

FIG. 45 is a front perspective view of the connecting assembly according to the third embodiment of the disclosure. In this embodiment, the separation preventing portion 3132C of the stopper 3130C is separated from the clamping recess 3125, for example, by a tool and then is pivoted downward around the axis of the pivoting coupler 3135C, thereby opening the closed shoulder harness detachment opening 3122. It can be seen from FIG. 45 that fixing concave 3126 is located in the clamping recess 3125 of the extension portion 3120 and corresponding to the fixing convex 3134C. According to this embodiment, the fixing concave 3126 is configured as through groove. The fixing concave 3126 may also be configured as non-through pit corresponding to the shape of the fixing convex 3134C, but the disclosure is not limited thereto. According to this embodiment, a larger force is needed to be exerted to open the stopper 3130C, for example, a tool may be needed to open it, such that the stopper 3130 can prevent the shoulder harness 3600 from separating out of the shoulder harness connection hole 3121 to the greatest extent.

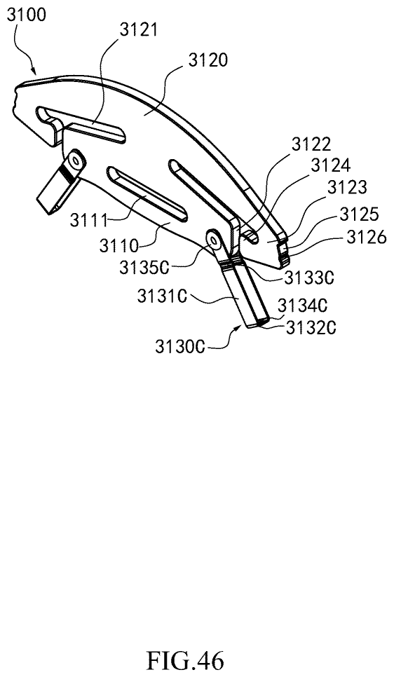

FIG. 46 is a side perspective view of the connecting assembly according to the third embodiment of the disclosure, in which the stoppers 3130C are opened. In FIG. 46, the fixing convex 3134C arranged on the separation preventing portion 3132C can be seen from inner side of the stopper 3130C. The fixing convex 3134C protrudes to the inner side of the stopper 3130C, such that the fixing convex 3134C can be clamped into the fixing concave 3126 arranged in the clamping recess 3125 to further provide a fixing force, thereby preventing the stopper 3130C from accidentally releasing the shoulder harness detachment opening 3122. In addition, it can be better seen that the structure of the recessed portion 3133C is recessed from both sides of the stopper body 3131C, thus adapting to the shape of the shoulder harness detachment opening 3122 and facilitating clamping and unclamping between the stopper 3130C and the end 3123, and can advantageously provide additional fixing force.

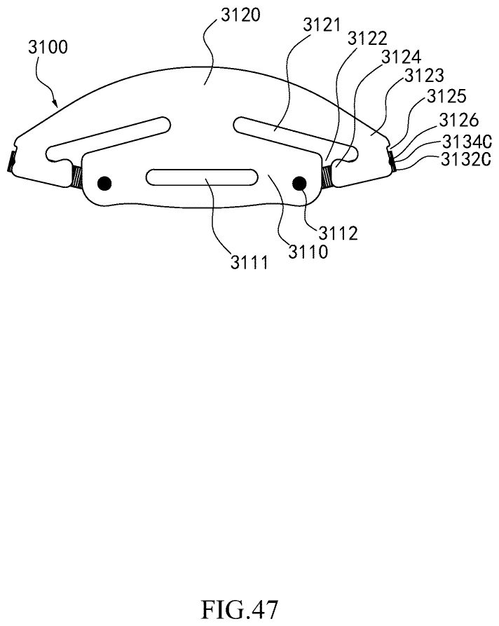

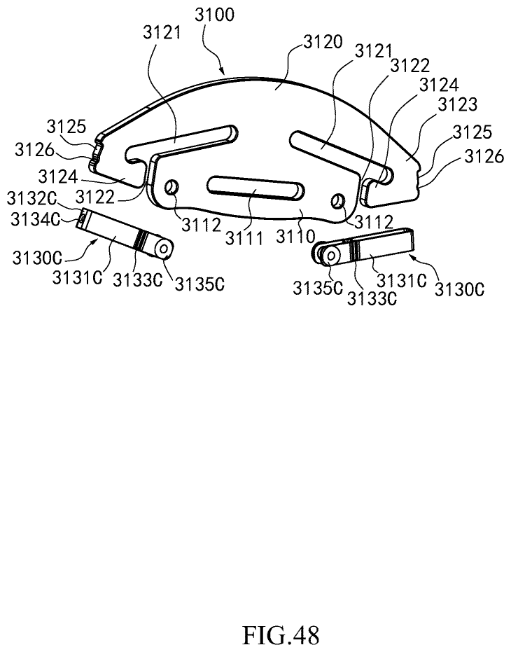

FIG. 47 shows a partial sectional view of the connecting assembly according to the third embodiment of the disclosure. FIG. 47 shows that the stoppers 3130C are cut open, wherein the separation preventing portions 3132C may not be entirely attached to the clamping recesses 3125, but clamped only by the fixing convexes 3134C and the fixing concaves 3126. It can also be seen from FIG. 48 that stopper coupling holes 3112 are arranged in the main body portion 3110 for inserting the pivoting couplers 3135C, such as pins, such that the stoppers 3130C can be pivoted around their axes.

FIG. 48 is an exploded perspective view of the connecting assembly according to the third embodiment of the disclosure. The stoppers 3130C may be made of, for example, two strip-shaped sheets which are separately processed, and corresponding two ends of each strip-shaped sheet are provided with corresponding perforations for the pivoting couplers 3135C to pass through. The pivoting couplers 3135C pass through the stopper coupling holes 3112 in an installed state.

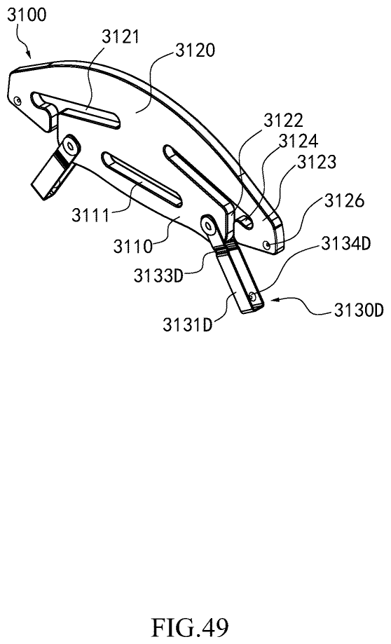

FIG. 49 is a perspective view of a connecting assembly according to a fourth embodiment of the disclosure, wherein the stoppers 3130D are opened. As shown in FIG. 49, on the inner side of the stopper 3130D, the fixing convex 3134D is arranged as the separation preventing portion, preferably, two fixing convexes are symmetrically arranged on the front and rear inner walls of the free end of each stopper 3130D, and the fixing concaves 3126 corresponding to the fixing convex 3134D are respectively on front and rear sides of the end 3123 of the extension portion 3120 of the connector body 3100. According to this embodiment, the fixing concaves 3126 are configured as pits. Of course, the fixing convex can also be only arranged on one of the front and rear inner walls of the stopper 3130, or alternatively, the fixing convex may be asymmetrically (in number or position) arranged on the front and rear inner walls of the free end of the stoppers 3130D, but the invention is not limited thereto. According to this embodiment, when the stoppers are clamped on the connector body, a larger force needs to be exerted to open, for example, a tool needs to be used to open them, such that the stoppers 3130D can prevent the shoulder harness 3600 from separating out of the shoulder harness connection holes 3121 to the greatest extent. In this embodiment, the fixing convex 3134D may be separated from the end 3123, e.g., by a tool, and the stopper 3130D is pivoted downward around the axes of the pivoting coupler 3135D, thereby opening the closed shoulder harness detachment opening 3122. In addition, the structures of the recessed portions 3133D may be recessed from both sides of the stopper body 3131D, thus adapting to the shape of the shoulder harness detachment opening 3122 and providing additional fixing force. Due to the curved shapes of the recessed portions 3133D, they can have certain elasticity, that is, they can be deformed when the stopper 3130D is pivoted upward to the end 3123, such that the fixing convex 3134D is clamped to the fixing concave 3126 at the end 3123, and the recessed portions 3133D can be restored after the fixing convex 3134D and the fixing concave 3126 are clamped in place, such that clamping between the fixing convex 3134D and the fixing concave 3126 is more stable.

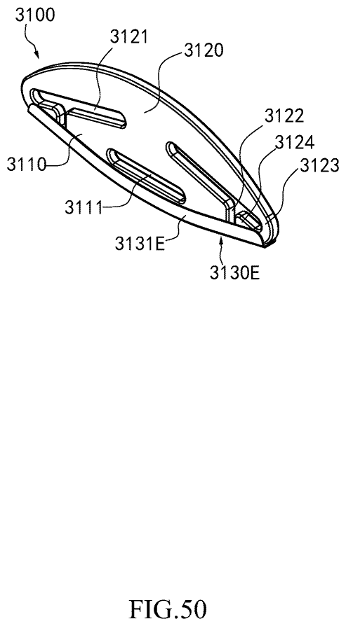

FIG. 50 shows an assembled side view of the connecting assembly according to the fifth embodiment of the disclosure according to this embodiment, the stopper body 3131E of the stopper 3130E is configured to extend towards both ends in the longitudinal direction to form the separation preventing portions, so as to be detachably connected to the ends 3123. The shape of the stopper body 3131E is adapted to the shapes of the lower portions of the main body portion 3110 and the extension portion 3120 of the connector body 3100. When the stopper 3130E is fixedly clamped to the connector body 3100, the stopper 3130E covers the shoulder harness detachment openings 3122, so as to prevent the shoulder harness 3600 from separating out of the detachment openings 3122. Other fixing means can be arranged between the inner side of the stopper body 3131E and the main body portion 3110 and the extension portion 3120 to form the separation preventing portions, so as to enhance the fixing force between the stopper 3130E and the connector body 3100.

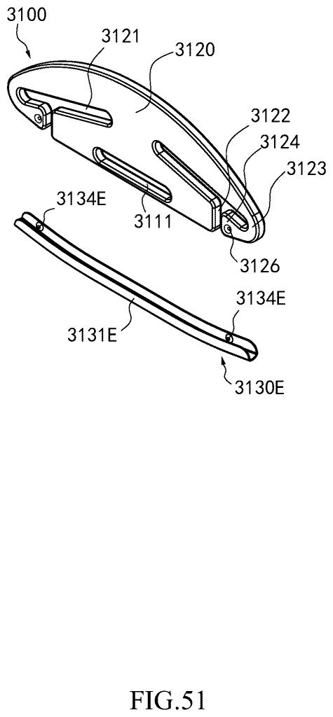

FIG. 51 is an exploded perspective view of the connecting assembly according to the fifth embodiment of the disclosure. According to this embodiment, the separation preventing portions are configured as fixing convexes 3134E from the front and rear walls of the stopper body 3131E to the opposite side walls, and the ends 3123 are provided with fixing concaves 3126 cooperating with the fixing convexes 3134E. Preferably, at least one fixing concave 3126 is respectively arranged on the two ends 3123, so as to provide symmetrical fixing points. Specifically, the stopper body 3131E and the ends 3123 may have separation preventing portions clamped to each other on the opposite connection surfaces, such as fixing convexes 3134E and corresponding fixing concaves 3126. In this embodiment, the stopper body 3131E of the stopper 3130E is provided with the inwardly protruding fixing convexes 3134E at both ends on inner sides, and correspondingly, the ends 3123 of the extension portion 3120 of the connector body 3100 are provided with the fixing concaves 3126 on both sides (only the front side can be seen in this figure), so as to realize a fixed connection between the stopper 3130E and the connector body 3100. For example, it may also be arranged that the separation preventing portion is configured as a fixing concave recessed from the front and rear walls of the stopper body 3131E away from the opposite side walls, and the ends 3123 are provided with the fixing convex cooperating with the fixing concaves.

In this embodiment, other fixing means, such as bonding and inserting, etc., can be arranged between the stopper 3130E and the ends 3123 or the lower side portion of the connector body 3100, and the disclosure is not limited thereto.

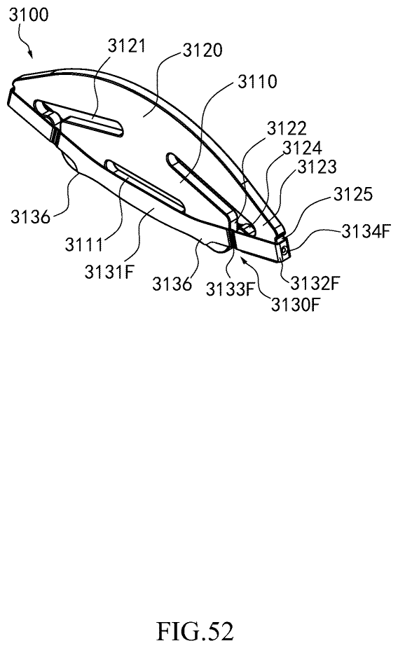

FIG. 52 is a side view of a connecting assembly according to a sixth embodiment of the disclosure. According to this embodiment, the stopper 3130F is configured as buckles at the ends similar to the buckle shown in FIGS. 41 to 48, that is, the separation preventing portions 3132F are is in the form of buckles, and the buckles are detachably clamped with the ends 3123 of the extension portion 3120 of the connector body 3100. The stopper body 3131F of the stopper 3130F is provided with fixing portions 3136, and the fixing portions 3136 are fixedly connected to the main body portion 3110 of the connector body 3100, for example, clamped in a shape matching manner, or in other ways.

According to this embodiment, after being detached from the connector body 3100, the stopper 3130F can be easily connected again, e.g., clamped to the connector body 3100, thereby enabling advantageous and convenient restoration of the connecting assembly while reducing the number of components.

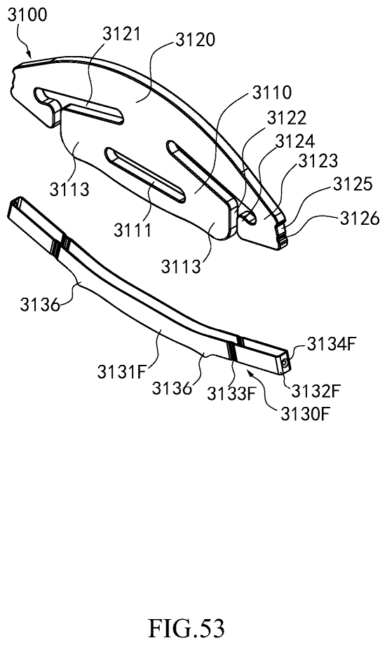

FIG. 53 is an exploded perspective view of the connecting assembly according to the sixth embodiment of the disclosure. As can be seen from the figure, fixing portions 3113 corresponding to the fixing portions 3136 are arranged on the lower side of the main body portion 3110 of the connector body 3100 in the height direction, such that the connector body 3100 can be easily fixed with the stopper 3130F. In this embodiment, clamped connection of the fixing convexes 3134F to the fixing concaves 3126, arrangements of the recessed portions 3133F and the shoulder harness detachment openings 3122 and the like can be referred to other embodiments, and will not be redundantly repeated here.

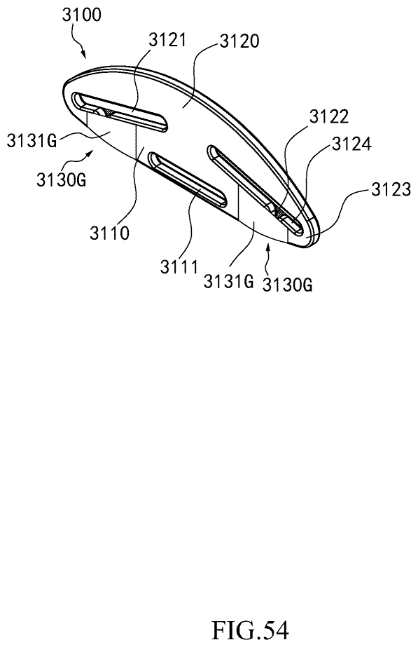

FIG. 54 is a side view of a connecting assembly according to a seventh embodiment of the disclosure. According to this embodiment, each stoppers 3130G is configured as a sheet that can be detached by a tool, such as an adhesive tape, a plastic sheet, a metal sheet, etc. The detachment openings 3122 are covered by the sheets at this time, so as to prevent the shoulder harness 3600 from separating out of the detachment openings 3122. Preferably, a sheet is folded to cover one detachment opening 3122 from multiple sides.

According to this embodiment, any of the stoppers 3130G can be an adhesive tape, which can be pasted on T-shaped iron sheets to cover the detachment openings 3122, so as to prevent the shoulder harness 3600 from separating out of the detachment openings 3122. Furthermore, on an outer surface 3131G of the adhesive tape, for example, a sign of cutting with scissors can be printed, so as to remind users that they need to use scissors to cut if they want to detach it. According to this embodiment, no additional components are needed, such that not only the cost is lower, but also the installation is more convenient.

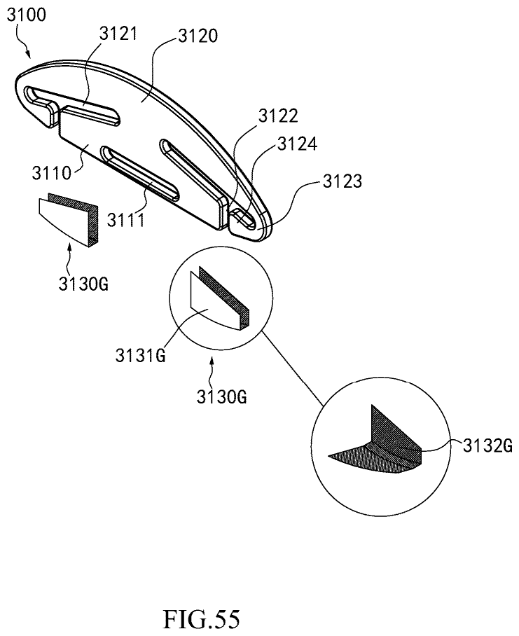

FIG. 55 is an exploded perspective view of the connecting assembly according to the seventh embodiment of the disclosure. According to this embodiment, for example, the stoppers 3130G may be deformed to cover the detachment openings 3122. One stopper 3130G can preferably be formed by folding a piece of an adhesive tape. In the Booster mode, the adhesive tape can be spreaded and stored, or it can be discarded and replaced with a replacement adhesive tape, thus lowering the cost and meeting requirements. Inner surfaces 3132G of the stoppers 3130G are used to engage with the connector body 3100, so as to prevent the stoppers 3130G from being detached from the connector body 3100. Engaging is, for example, bonding, welding and the like.

According to the disclosure, a stopper is provided. The stopper is used to be connected to a connector body 3100, such as a T-shaped iron sheet, between a shoulder harness 3600 and an adjusting strap 3500, and a detachment opening of the T-shaped iron sheet is sealed by the stopper itself with, for example, elastic force, clamping force, adhesive force and the like. In Harness usage mode, the shoulder harness 3600 is prevented from separating away to ensure normal function of Harness usage mode; moreover, after detachment, the stopper can be restored under the action of its own elastic force or its own structure or under the action of other fixed connections, so as not to cause damage to the stopper.

Since the disclosure can be carried out in various forms without departing from its spirit and essence, it should be understood, the above embodiments are not limited to any of the foregoing details, but should be interpreted as broadly as possible within the scope defined by the claims, and therefore all changes that fall within the scope of the claims or their equivalents should be covered by the claims.

### LIST OF REFERENCE SIGNS

1, 1A: Child Safety Seat
1100: Side-impact protection mechanism
1110: Side-impact protection block
1111: Knob
1112: Spring
1113: Clamping block
11131: Mounting end
11132: Clamping end
1114: Housing
   1120: Fixed base
      1121: Mounting hole
1122: Clamping hole
1123: Pivoting portion
1200: Side wing (Also Called “Side wing portion”)
1300: Backrest (Also Called “Backrest portion”)
1400: Opening for car-mounted safety belt to pass through
1500: Seat (Also Called “Seat portion”, “Seat part”)
1510: Seat armrests (Also Called “Seat portion armrest”, “Armrest”)
1600: gripper
1700: Guide
1800: Pillow (Also Called “Headrest”, “Headrest portion”)
2100, 2100A, 2100B, 2100C, 2100D, 2100E, 2100F: Front backrest reinforcing mechanism (Reinforcing sheet)
   2110, 2110A, 2110B, 2110C, 2110D, 2110E, 2110F: Body
      2111, 2111A, 2111D, 2111E, 2111F: Buffer portion
         21111B, 21111F: First buffer portion
         21112B, 21112F: Second buffer portion
         21113B, 21113C: Third buffer portion
      2112, 2112A, 2112B, 2112C, 2112D, 2112E: Bulge
         21121F: First bulge
         21122F: Second bulge
         21123F: third bulge
      2113, 2113A, 2113B: Pre-positioning hole
   2120, 2120A, 2120B, 2120C, 2120D, 2120E, 2120F: Clamping Portion
      2121, 2121A, 2121B, 2121C, 2121D, 2121E, 2121F: Open hole
      2122F: Welding portion
   2130, 2130A, 2130B, 2130C, 2130D, 2130E, 2130F: Edge portion
      2131, 2131A, 2131B, 2131C, 2131D, 2131E, 2131F: Perforation
   2140: Wing panel
2200: Side wing portion (Also Called “Side wing”)
   2210: Side wing foam
2300, 2300A: Backrest portion (Also Called “Backrest”)
   2310, 2310A: Backrest body
   2320, 2320A: Connecting hook
      2321: limiting bulged rib
      2322, 2322A: Connecting hook extension
      2323: locking projection
      2323A: locking hole
   2330: Fixing hole
   2340, 2340A: Cover plate
   2350: Engaging portion
   2360: Positioning portion
2400: Opening for car-mounted safety belt to pass through
2500: Seat portion (Also Called “Seat”, “Seat part”)
   2510: Seat portion armrest (Also Called “Seat armrest”, “Armrest”)
   2520: Cup holder
   2530: Concave portion
   2540: Clamping rod
   2550: Clamping port
2600: Guide
2700: Gripper
2800: Rear backrest reinforcing mechanism
   2810: Upper first rod
   2820: Second rod
   2830: Lower first rod
   2840: Locking rod
      2841: Connection hole (e.g., Screw connection hole)
      2842: Spring receiving portion
         28421: Avoidance notch
         28422: Limit post
      2850: Chute
      2860: Sliding member (e.g., Screw)
      h1: Limit hole
      2870: Pin
      2880: Resetting spring
      2890: Linkage rod
2900: Headrest (Also Called “Pillow”, “Headrest portion”)
3100: Connector body
3110: Main body portion
3111: Adjusting strap connection hole
3112: Stopper coupling hole
3113: Fixing portion
3120: Extension portion
3121: Shoulder harness connection hole
3122: Detachment opening, Shoulder harness detachment opening
3123: End
3124: Protruding portion
3125: Clamping recess
3126: Fixing concave
3130A, 3130B, 3130C, 3130D, 3130E, 3130F, 3130G: Stopper
   3131A, 3131B, 3131C, 3131D, 3131E, 3131F: Stopper body, 3131G: Outer surface
   3132A, 3132B, 3132C, 3132F: Separation preventing portion, 3132G: Inner surface
   3133B, 3133C, 3133D, 3133F: Recessed portion
   3134B, 3134C, 3134D, 3134E, 3134F: Fixing convex
   3135B, 3135C: Pivoting coupler
3136: Fixing portion
3200: Seat part (Also Called “Seat portion”, “Seat”)
3210: A-LOCK
3220: Accommodating recess
3300: Backrest portion (Also Called “Backrest”)
3400: Headrest portion (Also Called “Headrest”, “Pillow”)
3500: Adjusting strap
3600: Shoulder harness
3700: Side wing portions (Also Called “Side wing”)
3800: Opening
3900: Armrest (Also Called “Seat portion armrest”, Seat armrest”)

1-10. (canceled)

11. A backrest reinforcing mechanism, wherein the backrest reinforcing mechanism is fixedly arranged on a front side and/or a rear side of a backrest portion of the child safety seat, so as to reinforce the backrest portion against deformation.

12. The backrest reinforcing mechanism according to claim 11, wherein:
the backrest reinforcing mechanism is a rear backrest reinforcing mechanism installed on the rear side of the backrest portion in a form of a detachable reinforcing bracket.

13. The backrest reinforcing mechanism according to claim 12, wherein:
the reinforcing bracket is fixed to the rear side of the backrest portion by a fastener, and a lower end of the reinforcing bracket is installed at a connection of the backrest portion and a seat portion of the child safety seat, wherein the lower end of the reinforcing bracket is retractable with respect to an upper end thereof.

14. The backrest reinforcing mechanism according to claim 13, wherein:
the reinforcing bracket comprises an operating assembly to operate the lower end of the reinforcing bracket to expand and retract with respect to the upper end thereof.

15. The backrest reinforcing mechanism according to claim 11, wherein:
the backrest reinforcing mechanism is a rear backrest reinforcing mechanism and comprises at least one first rod and at least one second rod fixedly connected to the first rod, the first rod and/or the second rod is fixed to the rear side of the backrest portion by a fastener and has respectively different extension directions;
wherein the backrest reinforcing mechanism further comprises at least one locking rod slidably sleeved with the at least one second rod, and one end of the at least one locking rod extends and protrudes from the sleeved at least one second rod, so as to be detachably installed at a corresponding position on the backrest portion.

16. The backrest reinforcing mechanism according to claim 11, wherein:
the backrest reinforcing mechanism is a rear backrest reinforcing mechanism and comprises an upper first rod and a lower first rod arranged apart from each other, and a left second rod and a right second rod arranged apart from each other, and the left second rod and the right second rod are respectively fixed to the upper first rod and the lower first rod, thus forming a frame;
the backrest reinforcing mechanism further comprises two locking rods corresponding to the left second rod and the right second rod, and the two locking rods are respectively sleeved on and extend out of the left second rod and the right second rod, so as to be detachably installed to the backrest portion.

17. The backrest reinforcing mechanism according to claim 15 wherein:
a lower side of the backrest portion is correspondingly provided with a connecting hook having a locking hole, the locking rod is inserted into the corresponding locking hole.

18. The backrest reinforcing mechanism according to claim 15, wherein:
a resetting spring is arranged between the locking rod and the sleeved second rod, and the resetting spring is used for exerting a force on the locking rod to urge the locking rod to extend outwards and insert into the corresponding locking hole.

19-21. (canceled)

22. The backrest reinforcing mechanism according to claim 11, wherein:
the backrest reinforcing mechanism is a reinforcing sheet, a shape of the reinforcing sheet is matched with that of the backrest portion, the reinforcing sheet is provided with a perforation for a fastener to pass through and be fixed to a fixing hole on the backrest portion, and the perforation is arranged in an edge portion of the reinforcing sheet.

23. The backrest reinforcing mechanism according to claim 11, wherein:
the backrest reinforcing mechanism is a reinforcing sheet, the reinforcing sheet has a body and an edge portion around the body and at least one buffer portion is formed in the body.

24. The backrest reinforcing mechanism according to claim 11, wherein:
the backrest reinforcing mechanism is a reinforcing sheet, the reinforcing sheet has a body, and the body is divided into four regions, i.e., upper, lower, left, and right regions, by a vertical reference line and a horizontal reference line, and one or more buffer portions are arranged in each region.

25. The backrest reinforcing mechanism according to claim 11, wherein:
the backrest reinforcing mechanism is a reinforcing sheet, a lower edge of the reinforcing sheet is further provided with a clamping portion, and a shape of the clamping portion is matched with that of a connecting hook at a lower end of the backrest portion, so as to be mutually clamped with the connecting hook.

26. The backrest reinforcing mechanism according to claim 11, wherein:
the backrest reinforcing mechanism is a reinforcing sheet, the reinforcing sheet has a body and a clamping portion connected to a lower end of the body and a wall thickness of the clamping portion is greater than or equal to that of the body.

27. The backrest reinforcing mechanism according to claim 26, wherein:
the clamping portion is integrally formed with the body, and a wall thickness of the reinforcing sheet ranges from 1.2 mm to 1.8 mm.

28. The backrest reinforcing mechanism according to claim 26, wherein:
the clamping portion is fixed to the body by welding, and the wall thickness of the clamping portion is greater than that of the body.

29. The backrest reinforcing mechanism according to claim 28, wherein the wall thickness of the body ranges from 1.2 mm to 1.5 mm, and the wall thickness of the clamping portion ranges from 1.6 mm to 2 mm.

30. The backrest reinforcing mechanism according to claim 11, wherein:
the backrest reinforcing mechanism has a body, at least one buffer portion is formed in the body and a region occupied by the buffer portion. is substantially symmetrically distributed on a surface of the body.

31. A child safety seat wherein the child safety seat comprises:
a seat portion
a backrest portion arranged above the seat portion; and the backrest reinforcing mechanism according to any of claim 11.

32. The child safety seat according to claim 31, wherein:
the child safety seat further comprises:
two side wing portions respectively arranged on two sides of the backrest portion and above a seat portion armrest of the seat portion; and
a headrest arranged on an upper portion of the backrest portion

33. The child safety seat according to claim 31, wherein:
a connecting hook with a locking hole is correspondingly arranged on a lower side of the backrest portion, and the backrest reinforcing mechanism is respectively inserted into the corresponding locking hole to be fixed on the backrest portion.

34-57. (canceled)
